(19) United States
(12) Patent Application Publication
(10) Pub. No.: US 2014/0270803 A1
(43) Pub. Date: Sep. 18, 2014

(54) OPTICAL TRANSMISSION USING POLARISATION DIVERSITY

(71) Applicant: Bengt-Erik Olsson, Hovas (SE)

(72) Inventor: Bengt-Erik Olsson, Hovas (SE)

(73) Assignee: Telefonaktiebolaget L M Ericsson (PUBL), Stockholm (SE)

(21) Appl. No.: 14/351,436

(22) PCT Filed: Oct. 11, 2011
(86) PCT No.: PCT/EP2011/067719

§ 371 Date: Apr. 11, 2014

(51) Int. Cl. H04B 10/25; H04B 10/61; H04B 10/532

(52) U.S. Cl. CPC H04B 10/2503; H04B 10/532; H04B 10/614
USPC 398/152

(57) ABSTRACT

Method, transmitter, receiver, and system for communicating information carried by a polarization divided optical signal in an optical fiber, comprising: producing and transmitting a polarization divided optical signal OTApol comprising optical sideband pairs SBLA, SBHA each having one sideband SBLA at a first polarization and an other sideband SBHA at a second polarization that is orthogonal to the first polarization, the one sideband and the other sideband carry the same set of information A; and receiving and detecting the polarization divided optical signal OTApol to produce an electrical signal RFApol corresponding to the polarization divided optical signal; down converting the electrical signal to produce, for each sideband pair, a first converted signal BBLA corresponding to the one sideband SBLA and a second converted signal BBHA corresponding to the other sideband SBHA; and extracting the set of information A for each sideband pair using a polarization diversity scheme.

### TECHNICAL FIELD

This disclosure relates to optical fiber communication and particularly to a transmitter, a receiver and a method for communicating information carried by a polarization divided optical signal.

### BACKGROUND

Today high capacity communication via optical fiber is commonly used, and optical networks using optical fibers have become even more widespread as they are suitable for handling the growing communication of various multimedia services and similar requiring high bandwidth.

Consequently there is an increased interest for transporting large volumes of information with high spectral efficiency in the optical domain.

Optical transmission systems of today are therefore using advanced modulation formats, e.g. such as Quadrature Phase Shift Keying (QPSK) and 16 Quadrature Amplitude Modulation (16-QAM) and similar. Herein, the information is carried in the amplitude and phase of the optical field rather than in the optical intensity as have been more traditional.

Normally, a so called coherent receiver must be used in order to demodulate optical signals carrying information in the amplitude and phase of the optical field. In a common known coherent receivers the incoming optical signal is mixed with the light from a Continuous Wave (CW) Local Oscillator (LO) and the electrical beat components generated upon square law photo detection in a photo detector are used as an electrical counterpart to the optical signal. Since the phase information is lost upon square law detection there are usually two configurations used in order to recover both phase and amplitude of the light.

The most straight forward way to recover both phase and amplitude is to use two parallel coherent receivers whose LO laser have 90° relative phase shift and with the LO laser frequency set to the center of the optical spectrum that is to be demodulated. The two 90^{°} phase shifted LO laser signals must be generated from the same laser and the 90° phase shifted signals are usually generated in an optical 90° hybrid. From these two entities, often called in-phase signal (I) and out of phase quadrature signal (Q) components, the full phase and amplitude information can be recovered in a Digital Signal Processor (DSP). This first detection method is usually called homodyne detection.

Another detection method commonly used to recover both phase and amplitude of the light is to place an optical LO signal outside the optical spectrum to be recovered by using only one LO and one photo detector with square law detection. In this case, the optical spectrum is converted into an Radio Frequency (RF) signal with the optical information spectrum centered at an RF frequency equal to the frequency separation between the LO and the center of the optical information spectrum. Subsequently the electrical RF signal can be down converted in the electrical domain into I and Q signals that will be equal to the I and Q signals obtained with homodyne detection described above. This second method is called heterodyne detection and has the benefit of requiring only one photo detector and no 90° optical hybrid.

However, since the whole optical signal is converted onto an RF frequency, the bandwidth of the photo detector and subsequent electronics of an optical heterodyne receiver must be at least twice compared to the corresponding components in an optical homodyne receiver where the optical signal is split into two base band signals.

Moreover, the beating between the LO and the incoming signal in an optical heterodyne receiver requires aligning of the optical polarization states. However, in a fiber optical communication system there is no possibility to control the optical polarization state of the optical signal propagating into the receiver. A common solution to the unknown polarization problem is to use two coherent homodyne or heterodyne receivers in a polarization diversity scheme. Here the optical input signal is decomposed into two orthogonal polarization signals that are detected separately. Since there is still no control of how the two polarization channels are decomposed in the diversity receiver, the data recovery of the two polarization channels are usually performed in a DSP utilizing a receiving polarization diversity scheme, e.g. implemented by means of any suitable MIMO-equalizer scheme. Those skilled in the art are well aware of a number of different MIMO-equalizer schemes that are suitable and they need no further description here.

FIG. 1 shows an implementation of a typical coherent polarization diversity heterodyne receiver 100. Before entering the receiver 100 it is preferred that a received optical signal OTA is filtered by an optical filter 110. The received optical signal OTA is then decomposed into two orthogonal optical polarizations by an optical polarization rotating arrangement 112 so as to form a first branch with a horizontally polarized signal and a second branch with a vertically polarized signal. The horizontally polarized signal in the first branch is then combined with an optical oscillator signal LO (e.g. at the frequency f_{C}) in a first combiner arrangement 114a, whereas the vertically polarized signal in the second branch is combined with the optical LO-signal in a second combiner arrangement 114b. The optical oscillator signal LO may be produced by an optical oscillator 115, e.g. a suitable laser arrangement. The first combined signal in the first branch is then converted to a first electrical RF-signal RF_{A}_{_{—}}_{horiz} in a first balanced optical detector 116a, whereas the second combined signal in the second branch is converted to a second electrical RF-signal RF_{A}_{_{—}}ᵥₑᵣₜ in a second balanced optical detector 116b. Usually, a balanced optical detector contains two photo diodes and some times a differential amplifier. The optical information are now carried by an RF carrier frequency f₁, these high frequency signals are usually electronically demodulated into base band signals I and Q before being digitized in an Analogue to Digital Converter 120 (ADC) and processed by an Digital Signal Processor 130 (DSP). To this end, a first RF-demodulator 118a is introduced in the first branch, whereas a second RF-demodulator 118b is introduced in the second branch. Naturally, there may be additional optical signals or channels of the same or similar type as OTA and then a corresponding number of additional sets of RF-demodulators are required.

As indicated in FIG. 1, a demodulation of the RF-signal RF_{A}_{_{—}}ᵥₑᵣₜ to a baseband signal may e.g. be accomplished by mixing the RF-signal RF_{A}_{_{—}}ᵥₑᵣₜ with an electrical LO-signal of frequency f₁. To this end, an in-phase component I may be obtained by using an RF oscillator 146 and a first RF mixer 147a to mix the RF-signal RF_{A}_{_{—}}ᵥₑᵣₜ with the electrical LO-signal in-phase. A quadrature component Q may be obtained by using the RF oscillator 145, an phase shifting device 149 and a second RF mixer 147b to mix the RF-signal RF_{A}_{_{—}}ᵥₑᵣₜ with the electrical LO-signal phase shifted by 90°. The same applies mutatis mutandis to a demodulation of the RF-signal RF_{A}_{_{—}}ₕₒᵣᵢₛ to a baseband signal. This is all well known to those skilled in the art and it needs no further description.

The number of optical components is greatly reduced by the use of an optical heterodyne receiver 100 as schematically illustrated in FIG. 1, at least compared to the use of an optical homodyne receiver. Since the cost of optical components totally dominates the cost of most optical receivers it follows that optical heterodyne detection has significant cost benefits compared to optical homodyne detection.

FIG. 2 is a schematic illustration of a well known optical transmitter arrangement 200 configured to operatively transmit the optical signal OTA mentioned above. The optical transmitter arrangement 200 comprises an electrical signal generator 210, an Optical Single Sideband Modulator 212 (OSSB) and an optical oscillator 214.

The optical oscillator 214 is configured to operatively generate an optical carrier signal LO (e.g. at a frequency f_{C}). The optical oscillator 214 may e.g. be a light emitting laser arrangement tuned at the appropriate frequency. The signal generator 210 is configured to operatively modulate a subcarrier (e.g. at a frequency f₁) with a baseband signal comprising a set of information A so as to produce an RF-signal RF_{A}. Indeed, it is common knowledge that an RF-signal may be readily created by modulating a carrier signal with a baseband signal comprising a set of information. The Optical Single Sideband Modulator 212 (OSSB) is configured to operatively modulate an optical carrier signal LO (e.g. at a frequency f_{C}) with the RF-signal RF_{A} so as to form the optical signal O_{TA} comprising said optical carrier f_{C} carrying a lower optical sideband SB₁ comprising said set of information A. Alternatively, the transmitter 200 may be configured to form an optical signal comprising said optical carrier f_{C} carrying a higher optical sideband comprising said set of information A.

As mentioned above, the type of coherent optical heterodyne receivers exemplified above with reference to FIG. 1 has significant cost benefits compared to the corresponding homodyne receivers. However, coherent optical heterodyne receivers still involve a significant cost increase compared to the simpler direct detection receivers that are traditionally used for consumer grade optical transmission systems and the like, e.g. such as on-off-keying (OOK) optical transmission system or similar. The cost increase comes primarily from the added number of optical components in the coherent receivers compared to the simpler receivers in consumer grade optical transmission systems and the like, typically using a single optical detector without the ability to enable coherent reception.

However, an advantage of the coherent optical receivers compared to the simpler consumer grade receivers using a single optical detector is the ability to demodulate optical signals with the highest spectral efficiency. This makes the coherent receivers suitable for high capacity Dense Wavelength Division Multiplexing (DWDM) systems and similar schemes wherein spectral efficiency is of utmost importance. However, in many short and metro distance networks spectral efficiency is not the top priority while low cost and simplicity are key issues. The types of coherent receivers discussed above are still too expensive for making their way into consumer grade optical networks and the like. This is indeed unfortunate since coherent receivers offers more benefits than just allowing advanced modulation formats for high spectral efficiency. Coherent receivers are e.g. necessary in order to allow efficient use of Digital Signal Processors (DSPs) in optical systems, were they e.g. can be used to mitigate Chromatic Dispersion (CD) and Polarization Mode Dispersion (PMD) as well as allowing linear channel equalization etc. It is also worth noting that consumer grade optical networks, such as many short- and metro distance networks, have significantly larger volumes than ultra-long hauls links, which makes the introduction of DSPs particularly cost effective.

### SUMMARY

In view of the above there seems to be a need for a coherent receiver having a minimum number of optical components to reduce the cost, while still allowing the introduction of a DSP for enabling e.g. linear channel equalization and mitigation of signal interferences such as Chromatic Dispersion (CD) and Polarization Mode Dispersion (PMD) etc.

At least some of the drawbacks indicated above have been eliminated or mitigated by an embodiment of the present solution providing a method for communicating information carried by a polarization divided optical signal in an optical fiber, which method comprises the actions of: producing and transmitting a polarization divided optical signal comprising optical sideband pairs each having one sideband at a first polarization and an other sideband at a second polarization that is orthogonal to the first polarization, and where the one sideband and the other sideband carry the same set of information; and receiving and detecting the polarization divided optical signal so as to produce an electrical signal corresponding to the polarization divided optical signal; and down converting the electrical signal so as to produce, for each sideband pair, a first converted signal corresponding to the one sideband and a second converted signal corresponding to the other sideband; extracting the set of information for each sideband pair using a polarization diversity scheme operating on the first converted signal and the second converted signal of each sideband pair.

At least some of the drawbacks indicated above have also been eliminated or mitigated by another embodiment of the present solution providing an optical transmitter arrangement configured operatively produce and transmit a polarization divided optical signal, wherein: an optical modulator arrangement is configured to operatively produce optical sideband pairs each having one sideband and an other sideband, where the one sideband and the other sideband carries the same set of information, and wherein an optical polarization rotating arrangement is configured to operatively produce the polarization divided optical signal by polarizing the sideband pairs such that the one sideband receives a first polarization and the other sideband receives a second polarization that is orthogonal to the first polarization.

At least some of the drawbacks indicated above have also been eliminated or mitigated by another embodiment of the present solution providing an optical polarization diversity receiver configured to operatively receive a polarization divided optical signal (e.g. OTApol, OTAB1pol, OTAB2pol or OTAB3pol) comprising optical sideband pairs each having one sideband at a first polarization and an other sideband at a second polarization that is orthogonal to the first polarization, where the one sideband and the other sideband carries the same set of, wherein: an optical converter arrangement is configured to operatively receive the polarization divided optical signal so as to produce a down converted optical signal corresponding to the polarization divided optical signal, and wherein an optical detector arrangement is configured to operatively detect the down converted optical signal so as to produce an electrical signal corresponding to the received polarization divided optical signal, and wherein an electrical converter arrangement is configured to operatively down convert the electrical signal so as to produce, for each sideband pair, a first converted signal corresponding to the one sideband and a second converted signal corresponding to the other sideband, and wherein a diversity arrangement is configured to operatively extract the set of information for each sideband pair using a polarization diversity scheme operating on the first converted signal and the second converted signal of each sideband pair.

At least some of the drawbacks indicated above have also been eliminated or mitigated by another embodiment of the present solution providing a system for communicating information carried by a polarization divided optical signal in an optical fiber, wherein: an optical transmitter is configured to operatively produce and transmit a polarization divided optical signal (e.g. OTApol, OTAB1pol, OTAB2pol or OTAB3pol) comprising optical sideband pairs each having one sideband and an other sideband, where the one sideband and the other sideband carries the same set of information, and wherein: an optical receiver of the transmitter is configured to operatively receive and detect the polarization divided optical signal so as to produce an electrical signal corresponding to the polarization divided optical signal, and configured to operatively down convert the electrical signal so as to produce, for each sideband pair, a first converted signal corresponding to the one sideband and a second converted signal corresponding to the other sideband, and configured to operatively extract the set of information for each sideband pair using a polarization diversity scheme operating on the first converted signal and the second converted signal of each sideband pair.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasized that the methods defined in the specification or the appended claims may comprise further steps in addition to those mentioned. In addition, the steps mentioned may, without departing from the present solution, be performed in other sequences than those given in the specification or the claims.

Further advantages of the present invention and embodiments thereof will appear from the following detailed description of the solution.

### BRIEF DESCRIPTION OF THE DRAWINGS

FIG. 1 is a schematic illustration of a known optical coherent polarization diversity heterodyne receiver 100;

FIG. 2 is a schematic illustration of a known optical transmitter 200;

FIG. 3a is a schematic illustration of an optical polarization diversity transmitter 300a according to an embodiment of the present solution;

FIG. 3b is a schematic illustration of a coherent optical polarization diversity heterodyne receiver 300b according to an embodiment of the present solution;

FIG. 4a is a schematic illustration of an optical polarization diversity transmitter 400a according to another embodiment of the present solution;

FIG. 4b is a schematic illustration of a coherent optical polarization diversity heterodyne receiver 400b according to another embodiment of the present solution;

FIG. 5a is a schematic illustration of an optical polarization diversity transmitter 500a according to another embodiment of the present solution;

FIG. 5a′ is a schematic illustration of an optical polarization diversity transmitter 500a′ according to another embodiment of the present solution;

FIG. 5b is a schematic illustration of a coherent optical polarization diversity heterodyne receiver 500b according to another embodiment of the present solution;

FIG. 6a is a schematic illustration of an optical polarization diversity transmitter 600a according to another embodiment of the present solution;

FIG. 6b is a schematic illustration of a coherent optical polarization diversity heterodyne receiver 500b in FIG. 5b now operating according to another embodiment of the present solution;

FIG. 6c is a schematic illustration of Poincaré sphere representation of desired polarization states;

FIG. 7 is a schematic flowchart which illustrates the operation of exemplifying embodiments of the present solution.

### DETAILED DESCRIPTION OF EMBODIMENTS

FIG. 3a shows a schematic illustration of an exemplifying optical polarization diversity transmitter 300a according to an embodiment of the present solution. The optical transmitter 300a is configured to operatively transmit a modulated polarization divided optical signal O_{TApol} into an optical fiber 220. The optical transmitter 300a comprises a signal generator 310, a first optical modulator 312a, a second optical modulator 312b, a first optical oscillator device 314a, a second optical oscillator device 314b and an optical polarization rotating arrangement 316.

The signal generator 310 is configured to operatively modulate both the phase and amplitude of an electrical subcarrier f_{S1} (e.g. at a frequency f₁) with a baseband signal comprising a set of information A so as to form an RF-signal RF_{A} comprising this set of information A carried by the electrical subcarrier f_{S1}. Various methods of forming an RF-signal as now described are commonly known by those skilled in the art and this needs no further description.

The set of information A mentioned above may be any set of information that can be converted into a form that is suitable for transmission by an optical transmitter arrangement, e.g. transmitted through an optic fiber or similar. The set of information may e.g. be the information in a data file, in an image, in a video, in a piece of music, in a speech, in a text or similar, or the information in any other item that can be provided to and/or from a suitable communication resource via an optical fiber or similar.

The first optical modulator 312a is configured to operatively modulate a first optical carrier Cₒₚₜ₁ (e.g. at a first carrier frequency f_{C1}) with the RF-signal RF_{A} to form a first modulated optical signal O_{A1} with a first optical sideband comprising the set of information A. The first optical subcarrier has a frequency corresponding to a difference (e.g. f_{C1}−f₁) between the first carrier frequency f_{C1} and the frequency f₁ of the electrical subcarrier f_{S1}. However, a sum (e.g. f_{C1}+f₁) may be equally applicable. Similarly, the second optical modulator 312b is configured to operatively modulate a second optical carrier Cₒₚₜ₂ (e.g. at a second carrier frequency f_{C2}) with the RF-signal RF_{A} to form a second modulated optical signal O_{A2} with a second optical sideband also comprising said set of information A but centered on a second optical subcarrier. The second optical carrier has a frequency corresponding to a difference (e.g. f_{C2}−f₁) between the second optical carrier frequency f_{C2} and the frequency f₁ of the electrical subcarrier f_{S1}. However, a sum (e.g. f_{C2}+f₁) may be equally applicable. It is preferred that the first optical carrier frequency f_{C1} is higher than the second optical carrier frequency f_{C2}. However, the opposite may be valid for some embodiments of the present solution.

It is well known to those skilled in the art that the first optical carrier Cₒₚₜ₁ may be produced by a first optical oscillator device 314a tuned at frequency f_{C1}, whereas the second optical carrier Cₒₚₜ₂ may be produced by a second optical oscillator device 314b tuned at frequency f_{C2}. The first optical oscillator device 314a and the second optical oscillator device 314b may each e.g. be a light emitting laser arrangement tuned at the appropriate frequency.

It is preferred that the optical carriers Cₒₚₜ₁ and Cₒₚₜ₂ are suppressed in the optical signals O_{A1} and O_{A2}. It is preferred that the optical modulators 312a and 312b are ordinary Optical Single Sideband (OSSB) modulators. The OSSB is preferably configured to operatively form a lower sideband or a higher sideband for each received set of information—e.g. carried by an electrical carrier (e.g. f_{S1}) in an RF-signal (e.g. RF_{A})—such that the sideband comprises the received set of information. The optical modulators 312a and 312b may each be a Mach Zehnder modulator arrangement configured to operatively produce an optical single sideband, preferably with a suppressed optical carrier.

The optical polarization rotating arrangement 316 is configured to operatively polarize the first modulated optical signal O_{A1} according to a first polarization, and to operatively polarize the second modulated optical signal O_{A2} according to a second polarization that is orthogonal to the first polarization and to form a combined polarization divided optical signal O_{TApol} comprising the polarized first modulated optical signal O_{A1} and the polarized second modulated signal O_{A2}. As can be seen in FIG. 3a, the divided multiplexed optical signal O_{TApol} comprises a higher optical sideband SB_{HA} with said set of information A at the first polarization and a lower optical sideband SB_{LA} with the same set of information A at the second polarization. Thus, the polarization divided optical signal O_{TApol} may be seen as a Sub Carrier Multiplexing (SCM) signal or similar.

The first polarization and the second polarization may e.g. be orthogonal with respect to each other e.g. when the first polarization and the second polarization are polarized at 900 with respect to each other. For example, the first polarization may be a horizontal polarisation whereas the second polarisation may be a vertical polarisation. Similarly, the first polarisation may be a polarisation at 0° whereas the second polarisation may be a polarisation at +90° or −90°; or the first polarisation may be a polarisation at 180° whereas the second polarisation may be a polarisation at +90° or −90° etc. It is preferred that the optical polarization rotating arrangement 316 is configured to operatively transmit the polarization divided optical signal O_{TApol} as a light wave through a fiber or similar. However, the transmission may be performed by or in conjunction with some other part of the optical polarization diversity transmitter 300a.

Before proceeding it should be clarified that a skilled person having the benefit of this disclosure realizes that a range of well known optical polarization rotating elements can be used to polarize the first modulated optical signal O_{A1} and the second modulated signal O_{A2} as described above. The optical polarization rotating arrangement 316 may e.g. utilise one or several of the optical polarization rotating elements that are described in the patent document U.S. Pat. No. 4,886,332 (Woffe) or in the patent document US 2004/0021940 A1 (Gunther et al).

The attention is now directed to FIG. 3b, which shows a schematic illustration of an exemplifying optical polarization diversity receiver 300b according to an embodiment of the present solution. The optical receiver 300b comprises an optical down converter arrangement 325, an optical detector arrangement 326, a RF-demodulator arrangement 328, and preferably a diversity arrangement 329.

The optical down converter arrangement 325 of the receiver 300b is configured to operatively receive and coherently down convert the transmitted polarization divided optical signal O_{TApol} so as to produce a down converted polarization divided optical signal O_{DApol} comprising a down-converted optical version of the sideband-pair SB_{HA}, SB_{LA}, i.e. a down-converted optical version of the higher sideband SB_{HA} and a down-converted optical version of the lower sideband SB_{LA}. As indicated in FIG. 3b, the received optical signal O_{TApol} may e.g. be down converted by combining the signal O_{TApol} with an optical oscillator signal LO (e.g. at the frequency f_{LO}), e.g. in an optical combining arrangement 325b. The LO-signal may e.g. be produced by an optical oscillator 325a, e.g. a laser arrangement tuned at the appropriate frequency. If we assume that the first optical carrier frequency f_{C1} is higher than the second optical carrier frequency f_{C2} then it is preferred that the frequency f_{LO} of the optical LO-signal is above the first optical carrier frequency f_{C}1 or below the second optical carrier frequency f_{C2} used by the optical transmitter 300a, though other frequencies are clearly conceivable provided that they are suitable for down converting the received optical signal O_{TApol}. Down converting a polarization divided optical signal (e.g. O_{TApol}) is a trivial task to those skilled in the art and it needs no further description.

The optical detector arrangement 326 of the receiver 300b is configured to operatively detect the down converted polarization divided optical signal O_{DApol} so as to produce an electrical RF-signal RF_{Apol} corresponding to the received polarization divided optical signal O_{TApol} and the down converted polarization divided optical signal O_{DApol}. Thus the electrical RF-signal RF_{Apol} comprises a down-converted electrical higher sideband SB′_{HA} and a down-converted electrical lower sideband SB′_{LA} corresponding to the optical higher sideband SB_{HA} and the optical lower sideband SB_{LA} respectively of the received optical signal O_{TApol}. It is preferred that the optical detector arrangement 326 comprises a single optical detector. The optical detector arrangement 326 may e.g. be a simple single optical detector. Alternatively, the optical detector arrangement 326 may e.g. be a single balanced optical detector comprising two optical detectors, see e.g. the first balanced optical detector 116a and the second balanced optical detector 116b described above with reference to FIG. 1. It is preferred that the optical detector of the optical detector arrangement 326 is an optical square law detector.

The RF-demodulator arrangement 328 of the receiver 300b is configured to operatively convert the RF-signal RF_{Apol} so as to produce a first converted signal BB_{LA} comprising the set of information A (preferably based on the lower sideband SB′_{LA} of the sideband-pair SB′_{LA}, SB′_{HA}), and so as to produce a second converted signal BB_{HA} comprising the same set of information A (preferably based on the higher sideband SB′_{HA} of the sideband-pair SB′_{LA}, SB′_{HA}). To this end it is preferred that the RF-demodulator arrangement 328 comprises a first RF-demodulator 328a arrangement configured to operatively down convert the lower sideband SB′_{LA} (corresponding to SB_{LA}) so as to produce the first converted signal BB_{LA} in the form of a baseband signal, and a second RF-demodulator 328b configured to operatively down convert the higher sideband SB′_{HA} (corresponding to SB_{HA}) so as to produce the second converted signal BB_{HA} in the form of a baseband signal. The first RF-demodulator 328a and the second RF-demodulator 328b may e.g. be of the same or similar kind as the RF-demodulators 118a and 118b described above with reference to FIG. 1. Thus, the first RF-demodulator 328a may be configured to produce an in-phase component I_{A1} and a quadrature component Q_{A1} of the first converted signal BBL, and the second RF-demodulator may 328b may be configured to produce an in-phase component I_{A2} and a quadrature component Q_{A2} of the second converted signal BB_{HA}. The RF-demodulators 328a and 328b may be analogue and/or digital arrangements.

The attention is now directed to the exemplifying diversity arrangement 329 of the receiver 300b. It is preferred that the diversity arrangement 329 is a part of the receiver 300b, though it may be a separate part communicating with the receiver 300b. The diversity arrangement 329 is configured to operatively extract the set of information A based on the first converted signal BB_{LA} and the second converted signal BB_{HA} both comprising the first set of information A. It is preferred that the diversity arrangement 329 is configured to operatively use a diversity scheme operating on the first converted signal BB_{LA} and the second converted signal BB_{HA} to extract the set of information A. It is preferred that the set of information A is extracted in the form of a single information signal Data_{A} comprising the set of information A. It is preferred that the set of information A is extracted with a signal quality (e.g. signal power and/or Signal to Noise Ratio, SNR or Bit Error Rate, BER or similar) that is above or at least equal to the signal quality provided by any one of the individual sidebands SBLA or SBHA of the received optical signal O_{TApol}.

It is preferred that the diversity scheme is a polarization diversity scheme. The diversity scheme may summarize the converted signals BB_{LA} and BB_{HA} and/or the diversity scheme may discharge one converted signal BB_{LA} or BB_{HA}, e.g. having a low signal quality (e.g. a high noise level or similar making it unsuitable for combining with the other converted signal). Those skilled in the art having the benefit of this disclosure realize that there are many other suitable diversity schemes that can be used in the diversity arrangement 329 to extract the set of information A.

The diversity scheme may e.g. be accomplish by a summation arrangement configured to operatively summarize the converted signals BB_{LA} and BB_{HA}. This is illustrated in FIG. 3b showing a first summarizing unit 329a and a second summarizing unit 329b. The first summarizing unit 329a is configured to operatively summarize the in-phase signal I_{A1} of the first converted signal BB_{LA} and the in-phase signal I_{A2} of the second converted signal BB_{HA} so as to produce an diversity extracted in-phase signal I_{A}. The second summarizing unit 329b is configured to operatively summarize the quadrature signal Q_{A1} of the first converted signal BB_{LA} and the quadrature signal Q_{A2} of the second converted signal BB_{HA} so as to produce an diversity extracted quadrature signal Q_{A}. In this case, the diversity extracted in-phase signal I_{A} and the diversity extracted quadrature signal Q_{A} form the diversity extracted information signal Data_{A} comprising the set of information A. The first summarizing unit 329a and the second summarizing unit 329b may be analogue and/or digital arrangements.

An embodiment of the diversity arrangement 329 may e.g. comprise an Analogue to Digital Converter arrangement ADC and a Digital Signal Processor DSP arrangement. The ADC may be configured to convert the first converted signal BB_{LA} and the second converted signal BB_{HA} to digital versions and provide the digital versions to the DSP. In turn, the DSP may be configured to implement the diversity scheme as indicated above so as to produce the output signal Data_{A}.

To illustrate the exemplifying operation of the optical polarization diversity transmitter 300a shown in FIG. 3a and the optical polarization diversity receiver 300b shown in FIG. 3b it may be noted that the transmitter 300a uses a first optical carrier Cₒₚₜ₁ at a frequency f_{C1}, a second optical carrier Cₒₚₜ₂ at a frequency f_{C2} and an electrical carrier f_{S1} at a frequency f₁. Similarly, it may be noted that the receiver 300b uses an optical LO signal at a frequency f_{LO} and a first RF-demodulator 328a providing the first converted signal BB_{LA} using a oscillator frequency f_{A1}=(f_{C2}−f_{LO})−f1, and a second RF-demodulator 328b providing the second converted signal BB_{HA} using a oscillator frequency f_{A2}=(f_{C1}−f_{LO})−f1. Naturally, embodiments of the present solution may use other frequencies for the various carrier signals and/or oscillator signals, provided that a transmitted combined polarization divided optical signal (e.g. such as O_{TApol}), comprising a set of information A in a sideband-pair SB_{LA} and SB_{HA} with orthogonal polarization can be down converted, detected and demodulated as indicated above.

As mentioned in the Background section, it is almost impossible to control the optical polarization of a signal transmitted through an optical fiber. Thus, the actual optical polarization of the sidebands SB_{LA}, SB_{HA} in the transmitted optical signal O_{TApol} is substantially unknown at the receiver 300b, which makes it complicated to achieve a polarization adjusted reception in ordinary optical receivers. However, in receiver 300b at least one of the orthogonally polarized sidebands SB_{HA}, SB_{HL} of the received optical signal O_{TApol} will always have a good signal quality. Thus, since both optical sidebands SB_{LA}, SB_{HA} comprise the same set of information A it is possible to use a diversity scheme operating on the two converted signals BB_{LA} and BB_{HA} corresponding to the optical sidebands SB_{LA} and SB_{HA} respectively to extract the set of information A as indicated above and assure that an output signal Data_{A} can be provided, preferably with a signal quality that is above or at least equal to the signal quality provided by any individual sideband SB_{LA} or SB_{HA} of the received optical signal O_{TApol}.

It should be particularly noted that the optical detector arrangement 326 may be a single optical detector that is configured to operatively provide a coherent optical detection of the received polarization divided optical signal O_{TApol}. This reduces the cost of the coherent polarization diversity heterodyne receiver 300b compared to the known coherent polarization diversity heterodyne receiver 100 that uses two different optical detectors 116a and 116b to provide a coherent optical detection, as discussed above with reference to FIG. 1. This provides a low cost coherent optical receiver that enables the use of a DSP, which is particularly advantageous in high volume consumer grade receivers.

The attention is now directed to FIG. 4a, showing a schematic illustration of another exemplifying optical polarization diversity transmitter 400a according to another embodiment of the present solution. The optical transmitter 400a is configured to operatively transmit a modulated polarization divided optical signal O_{TAB1pol} into an optical fiber 220. The optical transmitter 400a comprises the same or similar signal generator 310, first optical modulator 312a, second optical modulator 312b, first optical oscillator device 314a, second optical oscillator device 314b and first optical polarization rotating arrangement 316 as the first optical transmitter 300a described above with reference to FIG. 3a.

In addition, the optical transmitter arrangement 400a comprises a second signal generator 410, a third optical modulator 412a, a fourth optical modulator 412b, a second optical polarization rotating arrangement 416 and an optical combining arrangement 418.

The second signal generator 410 of the transmitter 400a corresponds to the first signal generator 310, except that the second signal generator 410 is configured to operatively modulate a second electrical subcarrier f_{S2} (e.g. at a frequency f₂) with a converted signal comprising a second set of information B to form an RF-signal RF_{B} comprising this second set of information B carried by the subcarrier f_{S2}. It is preferred that the second signal generator 410 is an electrical signal generator.

The second set of Information B may correspond to the first set of information A previously described. Thus, the first set of information A and the second set of information B may be of the same or similar category. However, the information content of the first set of information A and the second set of information B must not necessarily be the same or identical. On the contrary, it is preferred that the first set of information A and the second set of information B represent different information content.

The third optical modulator 412a of the transmitter 400a corresponds to the first optical modulator 312a. However, the third optical modulator 412a is configured to operatively modulate the first optical carrier Cₒₚₜ₁ with the second RF-signal RF_{B} to form a third modulated optical signal O_{B1} with a third optical sideband comprising the second set of information B. The third optical subcarrier has a frequency corresponding to a difference (e.g. f_{C1}−f₂) between the first optical carrier frequency f_{C1} and the frequency f₂ of the second electrical subcarrier f_{S2}. However, a sum (e.g. f_{C1}+f2) may be equally applicable.

The fourth optical modulator 412b of the transmitter 400a corresponds to the second optical modulator 312b. However, the fourth optical modulator 412b is configured to operatively modulate the second optical carrier Cₒₚₜ₂ with the second RF-signal RF_{B} to form a fourth modulated optical signal O_{B2} with a fourth optical sideband SB_{LB} also comprising the second set of information B. The fourth optical subcarrier has a frequency corresponding to a difference (e.g. f_{C2}−f₂) between the second optical carrier frequency f_{C2} and the frequency f₂ of the second electrical subcarrier f_{S2}. However, a sum (e.g. f_{C2}+f2) may be equally applicable.

It is preferred that the optical carriers Cₒₚₜ₁ and Cₒₚₜ₂ are suppressed in the optical signals O_{B1} and O_{B2}.

The second optical polarization rotating arrangement 416 of the transmitter 400a corresponds to the first optical polarization rotating arrangement 316, except that the second optical polarization rotating arrangement 416 is configured to operatively polarize the third modulated optical signal O_{B1} according to a third polarization, and to operatively polarize the fourth modulated optical signal O_{B2} according to a fourth polarization that is orthogonal to the third polarization and to form a combined polarization divided optical signal O_{TBpol} comprising the polarized third modulated optical signal O_{B1} and the polarized fourth modulated signal O_{B2}. As can be seen in FIG. 4a, the polarization divided optical signal O_{TBpol} comprises a higher optical sideband SB_{HB} with said second set of information B at the third polarization and a lower optical sideband SB_{LA} with the same set of information B at the fourth polarization. Thus, the polarization divided optical signal O_{TBpol} may be seen as a Sub Carrier Multiplexing (SCM) signal or similar. The third polarization and the fourth polarization may be the same or similar as the first polarization and the second polarization respectively that were previously described with reference to FIG. 3a. Alternatively, the third polarization and the fourth polarization may be the same or similar as the second polarization and the first polarization respectively. Alternatively, the first polarization and the second polarisation may be selected substantially independently from the third polarization and the fourth polarization, provided that the third polarization and the fourth polarizations are still substantially orthogonal with respect to each other.

The optical combining arrangement 418 of the transmitter 400a is configured to operatively combine the first polarization divided optical signal O_{TApol} and the second polarization divided optical signal O_{TBpol} so as to produce the combined polarization divided optical signal O_{TAB1pol}. As can be seen in FIG. 4a, the combined polarization divided optical signal O_{TAB1pol} comprises the first set of information A in a first sideband-pair SB_{LA}, SB_{HA} and the second set of information B in a second sideband-pair SB_{LB}, SB_{HBA}. The sidebands in each individual sideband-pair have an orthogonal polarization with respect to each other. The sidebands in an individual sideband-pair comprise the same set of information.

Compared to the first combined polarization divided optical signal O_{TApol} produced by transmitter 300a in FIG. 3a, it is clear that the combined polarization divided optical signal O_{TAB1pol} produced by transmitter 400a may comprise twice the amount of information, however at the cost of using two of optical modulators and two of optical polarization rotating arrangements.

The attention is now directed to FIG. 4b, which shows a schematic illustration of another exemplifying optical polarization diversity receiver 400b according to another embodiment of the present solution. The optical receiver 400b comprises the same or similar down converter arrangement 325, optical detector arrangement 326 and RF-demodulator arrangement 328 as the first optical receiver 300b discussed above with reference to FIG. 3b. In addition, the optical receiver 400b comprises a second RF-demodulator arrangement 428. It is also preferred that the receiver arrangement 400b comprises a diversity arrangement 429.

The optical down converter arrangement 325 of the receiver 400b is configured to operatively receive and coherently down convert the transmitted polarization divided optical signal O_{TAB1pol} so as to produce a down converted polarization divided optical signal O_{DAB1pol} comprising a down converted optical version of the first sideband-pair SB_{HA}, SB_{LA} and a down converted version of the second sideband-pair SB_{HB}, SB_{LB}.

The optical detector arrangement 326 of the receiver 400b is configured to operatively detect the down converted polarization divided optical signal O_{DAB1pol} so as to produce an electrical RF-signal RF_{AB1pol} corresponding to the received polarization divided optical signal O_{TAB1pol} and the down converted polarization divided optical signal O_{DAB1pol}. Thus the electrical RF-signal RF_{AB1pol} comprises a down-converted electrical higher sideband SB′_{HA} and a down-converted electrical lower sideband SB′_{LA} corresponding to the optical higher sideband SB_{HA} and the optical lower sideband SB_{LA} respectively of the received optical signal O_{TAB1pol}. In addition, the electrical RF-signal RF_{AB1pol} will comprise a down-converted electrical higher sideband SB′_{HB} and a down-converted electrical lower sideband SB′_{LB} corresponding to the optical higher sideband SB_{HB} and the optical lower sideband SB_{LB} respectively of the received optical signal O_{TAB1pol}.

The first RF-demodulator arrangement 328a of the receiver 400b is configured to operatively convert the electrical RF-signal RF_{AB1pol} so as to produce a first converted signal BB_{LA} comprising the first set of information A (preferably based on the lower sideband SB′_{LA} of the first sideband-pair SB′_{LA}, SB′_{HA}), and so as to produce a second converted signal BB_{HA} comprising the same first set of information A (preferably based on the higher sideband SB′_{HA} of the first sideband-pair SB′_{LA}, SB′_{HA}).

The second RF-demodulator arrangement 428 of the receiver 400b corresponds to the first RF-demodulator arrangement 328 of the receiver 300b. Thus, the second RF-demodulator arrangement 428 is configured to operatively convert the electrical RF-signal RF_{AB1pol} so as to produce a third converted signal BB_{LB} comprising the second set of information B (preferably based on the lower sideband SB′_{LB} of the second sideband-pair SB′_{LB}, SB′_{HB}), and so as to produce a fourth converted signal BB_{HB} comprising the same second set of information B (preferably based on the higher sideband SB′_{HB} of the second sideband-pair SB′_{LB}, SB′_{HB}). To this end it is preferred that the RF-demodulator arrangement 428 comprises a third RF-demodulator 428a that is configured to operatively down convert the lower sideband SB′_{LB} (corresponding to SB_{LB}) so as to produce the third converted signal BB_{LB} (preferably in the form of a baseband signal), and a fourth RF-demodulator 428b configured to operatively down convert the higher sideband SB′_{HB} (corresponding to SB_{HB}) so as to produce the fourth converted signal BB_{HB} (preferably in the form of a baseband signal). The RF-demodulators 428a and 428b may be of the same or similar kind as the RF-demodulators 118a and 118b described above with reference to FIG. 1. The RF-demodulators 428a and 428b may be analogue and/or digital arrangements.

The attention is now directed to the exemplifying diversity arrangement 429 of the receiver 400b. It is preferred that the diversity arrangement 429 is a part of the optical receiver 400b, though it may be a separate part communicating with the receiver 400b. The diversity arrangement 429 is configured to operatively extract the first set of information A based on the first converted signal BB_{LA} and the second converted signal BB_{HA} both comprising the first set of information A, and to operatively extract the second set of information B based on the third converted signal BB_{LB} and the fourth converted signal BB_{HB} both comprising the second set of information B. It is preferred that the diversity arrangement 429 is configured to operatively use a diversity scheme operating on the first converted signal BB_{LA} and the second converted signal BB_{HA} to extract the first set of information A, and operating on the third converted signal BB_{LB} and the fourth converted signal BB_{HB} to extract the second set of information B. It is preferred that the first set of information A is extracted in the form of a first single information signal Data_{A} comprising the first set of information A, and that the second set of information B is extracted in the form of a second single information signal Data_{B} comprising the second set of information B. It is preferred that the first set of information A is extracted with a signal quality (e.g. signal power and/or Signal to Noise Ratio, SNR or Bit Error Rate, BER or similar) that is above or at least equal to the signal quality provided by any one of the individual sideband SB_{LA} or BB_{HA} of the received optical signal O_{TAB1pol}. Similarly, it is preferred that the second set of information B is extracted with a signal quality that is above or at least equal to the signal quality provided by any one of the individual sideband SB_{LB} or BB_{HB} of the received optical signal O_{TAB1pol}.

It is preferred that the diversity scheme may is a polarization diversity scheme. The diversity scheme may e.g. summarize the converted signals BB_{LA} and BB_{HA}, and summarize the converted signals BB_{LB} and BB_{HB}. The diversity scheme may discharge one converted signal BB_{LA} or BB_{HA}, and discharge one converted signal BB_{LB} or BB_{HB}. The discharged converted signal may e.g. have a low signal quality (e.g. a high noise level or similar making it unsuitable for combining with the other converted signal). Those skilled in the art having the benefit of this disclosure realize that there are many other suitable diversity schemes that can be used in the diversity arrangement 429 to extract the first set of information A and the second set of information B.

The diversity scheme may e.g. be accomplish by a summation arrangement configured to operatively summarize the converted signals in each signal pair BB_{LA}, BB_{HA} and BB_{LB}, BB_{HB}. This is illustrated in FIG. 4b showing a first summarizing unit 329a, a second summarizing unit 329b, a third summarizing unit 429a and a fourth summarizing unit 429b. Here, the first summarizing unit 329a is configured to operatively summarize the in-phase signal I_{A1} of the first converted signal BB_{LA} and the in-phase signal I_{A2} of the second converted signal BB_{HA} so as to produce a diversity extracted in-phase signal I_{A}. Similarly, the second summarizing unit 329b is configured to summarize the quadrature signal Q_{A1} of the first converted signal BB_{LA} and the quadrature signal Q_{A2} of the second converted signal BB_{HA} so as to produce an diversity extracted quadrature signal Q_{A}. Here, the in-phase signal I_{A} and the quadrature signal Q_{A} from the diversity extracted information signal Data_{A} comprising the first set of information A. In turn, the third summarizing unit 429a is configured to operatively summarize the in-phase signal I_{B1} of the third converted signal BB_{LB} and the in-phase signal I_{B2} of the fourth converted signal BB_{HB} so as to produce an diversity extracted in-phase signal I_{B}. Similarly, the fourth summarizing unit 429b is configured to summarize the quadrature signal Q_{B1} of the third converted signal BB_{LB} and the quadrature signal Q_{B2} of the fourth converted signal BB_{HB} so as to produce a diversity extracted quadrature signal Q_{B}. Here, it is preferred that the in-phase signal IB and the quadrature signal Q_{B} from the diversity extracted information signal Data_{B} comprising the second set of information B.

The summarizing units 329a, 329b, 429a and 429b may be analogue and/or digital arrangements.

An embodiment of the diversity arrangement 429 may e.g. comprise an Analogue to Digital Converter arrangement ADC and a Digital Signal Processor arrangement DSP. The ADC may be configured to convert the first signal pair BB_{LA}, BB_{HA} and the second signal pair BB_{LB}, BB_{HB} to digital versions and provide the digital versions to the DSP. In turn, the DSP may be configured to implement the diversity scheme as indicated above so as to produce the output signals Data_{A} and Data_{B}.

As mentioned in the Background section, it is almost impossible to control the optical polarization of a signal transmitted through an optical fiber, which makes it complicated to achieve a polarization adjusted reception in ordinary optical receivers. However, in receiver 400b at least one of the orthogonally polarized sidebands SB_{HA}, SB_{HL} and at least one of the orthogonally polarized SB_{HB}, SB_{LB} of the received optical signal O_{TAB1pol} will always have a sufficient signal quality. Thus, since both sidebands SB_{HA}, SB_{HL} comprise the same first set of information A and since both sidebands SB_{HB}, SB_{HB} comprise the same second set of information B it is possible to use a diversity scheme operating on the converted signals BB_{LA}, BB_{HA} and BB_{LB}, BB_{HB} respectively to extract the first set of information A and the second set of information B respectively as indicated above, so as to assure that an output signal Data_{A} can be provided, preferably with a signal quality that is above or at least equal to the signal quality provided by any individual sideband SB_{HA}, SB_{LA}, SB_{HB}, SB_{LB} of the received optical signal O_{TAB1pol}.

To illustrate the exemplifying operation of the optical polarization diversity transmitter 400a shown in FIG. 4a and the optical polarization diversity receiver 400b shown in FIG. 4b it may be noted that the transmitter 400a uses a first optical carrier Cₒₚₜ₁ at a frequency f_{C1}, a second optical carrier Cₒₚₜ₂ at a frequency f_{C2}, a first subcarrier f_{S1} at a frequency f₁, and a second subcarrier f_{S2} at a frequency f₂. Similarly, it may be noted that the receiver 400b uses an optical LO signal at a frequency f_{LO} and a first RF-demodulator 328a providing the first converted signal BB_{LA} using a oscillator frequency f_{A1}=(f_{C2}−f_{LO})−f1, and a second RF-demodulator 328b providing the second converted signal BB_{HA} using a oscillator frequency f_{A2}=(f_{C1}−f_{LO})−f1, and a third RF-demodulator 428a providing the third converted signal BB_{LB} using a oscillator frequency f_{B1}=(f_{C2}−f_{LO})−f₂, and a fourth RF-demodulator 428b providing the fourth converted signal BB_{HB} using a oscillator frequency f_{B2}=(f_{C1}−f_{LO})−f₂. Naturally, embodiments of the present solution may use other frequencies for the various carrier signals and/or oscillator signals, provided that a transmitted combined polarization divided optical signal (e.g. such as O_{TAB1pol}) can be down converted, detected and demodulated as indicated above.

An advantage of the optical polarization diversity transmitter 400a and the optical polarization diversity receiver 400b is the ability of handling two sideband-pairs, SB_{LA}, SB_{HA} and SB_{LB}, SB_{LH} each comprising an individual set of information A and B respectively. Those skilled in the art having the benefit of this disclosure realize that further sideband-pairs can be introduced by providing the transmitter 400a with an additional version of the second signal generator 410, the third optical modulator 412a, the fourth optical modulator 412b and the second optical polarization rotating arrangement 416 configured to handle an additional set of information, and by providing the receiver 400b with an additional version of the second RF-demodulator arrangement 428 and another version of the diversity arrangement 429 adapted so as to extract an additional information signal comprising the additional set of information.

It should be particularly noted that the optical detector arrangement 326 of the optical polarization diversity receiver 400b in FIG. 4b may be a single optical detector that is configured to operatively provide a coherent optical detection of the received optical signal O_{TAB1pol}.

The attention is now directed to FIG. 5a, showing a schematic illustration of another exemplifying optical polarization diversity transmitter 500a according to another embodiment of the present solution. The optical transmitter 500a is configured to operatively transmit a modulated polarization divided optical signal O_{TAB2pol} into an optical fiber 220. The optical transmitter 500a comprises a signal generator 510, an optical modulator 512, an optical oscillator device 514, and an optical polarization rotating arrangement 516.

The optical oscillator device 514 of the transmitter 500a is configured to produce an optical carrier signal Copt at a frequency f_{C}. The optical oscillator device 514 may e.g. be a light emitting laser arrangement or similar tuned at the appropriate frequency.

The signal generator 510 of the transmitter 500a is configured to operatively modulate a first subcarrier f_{S1} (e.g. at a frequency f₁) with a first baseband signal comprising a first set of information A, and to modulate a second subcarrier f_{S2} (e.g. at a frequency f₂) with a second baseband signal comprising a second set of information B so as to form an RF-signal RF_{AB} comprising the first set of information A carried by the first subcarrier f_{S1} and the second set of information B carried by the second set of information B. It is preferred that the signal generator 510 is an electrical signal generator.

The optical modulator 512 of the transmitter 500a is configured to operatively modulate the optical carrier Copt with the RF-signal RF_{AB} so as to form a modulated optical signal O_{AB1} comprising a first sideband-pair SB_{LAM}, SB_{HAM} carrying the first set of information A and a second sideband-pair SB_{LBM}, SB_{HBM} carrying the second set of information B. The first sideband-pair comprises a lower sideband SB_{LAM} that is centered on a first optical subcarrier. The first optical subcarrier has a frequency corresponding to a difference (e.g. f_{C}−f₁) between the optical carrier frequency f_{C} and the frequency f₁ of the first electrical subcarrier f_{S1}. In addition, the first sideband-pair comprises a higher sideband SB_{HAM} that is centered on a higher second optical subcarder. The second optical subcarrier has a frequency corresponding to a sum (e.g. f_{C}+f₁) of the optical carrier frequency f_{C} and the frequency f₁ of the first electrical subcarrier f_{S1}. Similarly, the second sideband-pair comprises a lower sideband SB_{LBM} that is centered on a third optical subcarrier. The third optical subcarrier has a frequency corresponding to a difference (e.g. f_{C}−f₂) between the optical carrier frequency f_{C} and the frequency f₂ of the second electrical subcarrier f_{S2}. In addition, the second sideband-pair comprises a higher sideband SB_{HBM} that is centered on a fourth optical subcarrier. The fourth optical subcarrier has a frequency corresponding to a sum (e.g. f_{C}+f₂) of the optical carrier frequency f_{C} and the frequency f₂ of the second electrical subcarrier f_{S2}.

It is preferred that the optical carrier Copt is suppressed in the optical signal O_{AB1}. It is preferred that the optical modulator 512 is an ordinary Optical Double-Sideband Modulator. The Optical Double-Sideband Modulator is preferably configured to operatively form a lower sideband (e.g. SB_{LAM}) and a higher sideband (e.g. SB_{HAM}) for each received set of information—e.g. carried by an electrical carrier (e.g. f_{S1}) in an RF-signal (e.g. RF_{AB})—such that both the lower sideband and the higher sideband comprises the received set of information. It is preferred that the modulator 512 is configured to operatively center the carrier signal Copt of the modulator 512 in the middle between the lower sideband and the higher sideband of the sideband pair(s). In other words, the lower sideband and the higher sideband are equally distributed around the carrier frequency f_{C} used by the optical modulator 512. It is preferred that the optical modulator 512 is a Mach Zehnder modulator arrangement configured to operatively produce optical double sidebands, preferably with a suppressed optical carrier.

The optical polarization rotating arrangement 516 of the transmitter 500a comprises a wavelength selective splitter device 516a and an optical polarization rotating element 516b. It should be noted that the optical polarization rotating arrangement 516 may also be used in the embodiments described above with reference to FIGS. 3a and 4a, at least if the lower and higher sidebands of the optical sideband-pairs are positioned at suitable frequencies, e.g. as indicated below.

The wavelength selective splitter device 516a of the polarization rotating arrangement 516 is configured to operatively receive and split the modulated optical signal O_{AB1} in at least a first modulated optical signal O_{AB1H} and a second modulated optical signal O_{AB1L}. It is preferred that the first modulated optical signal O_{AB1H} comprises the higher sidebands of the sideband-pairs, e.g. SB_{HAM} and SB_{HBM} of SB_{LAM}, SB_{HAM} and SB_{LBM}, SB_{HBM}. Typically, this corresponds to the frequencies above the optical carrier frequency f_{C} used by the modulator 512. Similarly, it is preferred that the second modulated optical signal O_{AB1L} comprises the lower sidebands of the sideband-pairs, e.g. SB_{LAM} and SB_{LBM} of SB_{LAM}, SB_{HAM} and SB_{LBM}, SB_{HBM}. Typically, this corresponds to the frequencies below the optical carrier frequency f_{C} used by the modulator 512.

The optical polarization rotating element 516b of the polarization rotating arrangement 516 is the same or similar as the polarization rotating arrangement 316 discussed above with reference to FIG. 3a. Thus, the optical polarization rotating element 516b is configured to operatively receive and polarize the first modulated optical signal O_{AB1H} (comprising the higher sidebands SB_{HAM} and SB_{HBM}) according to a first polarization, and to operatively receive and polarize the second modulated optical signal O_{AB1L} (comprising the lower sidebands SB_{LAM} and SB_{LBM}) according to a second polarization that is orthogonal to the first polarization and to operatively form a combined polarization divided optical signal O_{TAB2pol}.

As can be seen in FIG. 5a, the combined polarization divided optical signal O_{TAB2pol} comprises the first set of information A in a first polarized sideband-pair SB_{LA2}, SB_{HA2} corresponding to the first sideband pair SB_{LAM}, SB_{HAM}, and the second set of information B in a second polarized sideband-pair SB_{LB2}, SB_{HBA5} corresponding to the second sideband pair SB_{LBM}, SB_{HBM}. The sidebands in each polarized sideband-pair have an orthogonal polarization with respect to each other. The sidebands in a polarized sideband-pair comprise the same set of information.

An advantage provided by the optical transmitter 500a is the simplicity at which a plurality of optical sideband-pairs each comprising an individual and unique set of information can be produced. This can be accomplished by simply configuring the signal generator 510 to operatively modulate each of a plurality of electrical subcarriers with an individual and unique set of information. The rest of the optical transmitter 500a can remain unchanged. For example, the optical transmitter 500a does not need any additional costly optical modulators and/or optical polarization arrangements etc to produce an additional optical sideband-pair, which is a contrast to the optical transmitter 400a in FIG. 4a.

The attention is now directed to FIG. 5a′, which shows a schematic illustration of another exemplifying optical polarization diversity transmitter 500a′ according to another embodiment of the present solution. The optical transmitter 500a′ is configured to operatively transmit a modulated multiplexed polarization divided optical signal O_{TABCDpol} into an optical fiber 220. The optical transmitter 500a′ comprises a first signal generator 510, optical modulator 512, a first optical oscillator device 514, and a first optical polarization rotating arrangement 516 as previously described above with reference to FIG. 5a. In addition, the optical transmitter 500a′ comprises a second signal generator 510′, a second optical modulator 512′ and a second wavelength selective splitter device 516a′.

The signal generator 510′ is, in the same or similar manner as the signal generator 510, configured to operatively modulate the first subcarrier f_{S1} with a third baseband signal comprising a third set of information C, and to modulate the second subcarrier f_{S2} with a fourth baseband signal comprising a fourth set of information D so as to form an RF-signal RF_{CD} comprising the third set of information C carried by the first subcarrier f_{S1} and the fourth set of information D carried by the second set of information B.

The optical modulator 512′ is, in the same or similar manner as the optical modulator 512, configured to operatively modulate the optical carrier Cₒₚₜ with the RF-signal RF_{CD} so as to form a modulated optical signal O_{CD1} comprising a third sideband-pair carrying the third set of information C and a fourth sideband-pair carrying the fourth set of information D. The third sideband-pair comprises a lower sideband that is centered on the same first optical subcarrier f_{C}−f₁ mentioned above in connection with the optical modulator 512, and a higher sideband that is centered on the same higher second subcarrier f_{C}+f₁ mentioned above in connection with the optical modulator 512. Similarly, the fourth sideband-pair comprises a lower sideband that is centered on a third optical subcarrer f_{C}−f2 mentioned above in connection with the optical modulator 512, and a higher sideband that is centered on a fourth optical subcarrier f_{C}+f₂) mentioned above in connection with the optical modulator 512.

The wavelength selective splitter device 516a′ is, in the same or similar manner as the wavelength selective splitter 516a, configured to operatively receive and split the modulated optical signal O_{CD1} in at least a first modulated optical signal OCDIH and a second modulated optical signal O_{CD1L}. It is preferred that the first modulated optical signal O_{AB1H} comprises the higher sidebands of the third and fourth sideband-pairs mentioned above. Typically, this corresponds to the frequencies above the optical carrier frequency f_{C} used by the modulator 512′. Similarly, it is preferred that the second modulated optical signal O_{CD1L} comprises the lower sidebands of the third and fourth sideband-pairs. Typically, this corresponds to the frequencies below the optical carrier frequency f_{C} used by the modulator 512′.

The optical polarization rotating element 516b is the same as in the transmitter 500a discussed above with reference to FIG. 5a. However, here the optical polarization rotating element 516b is additionally configured to operatively receive and polarize the second modulated optical signal O_{CD1L} (comprising the lower sidebands of O_{CD1}) according to the first polarization, and to operatively receive and polarize the first modulated optical signal O_{CD1H} (comprising the higher sidebands of O_{CD1}) according to the second polarization so as to operatively form a combined polarization divided optical signal O_{TABCDpol}.

As can be seen in FIG. 5a′, the multiplexed polarization divided optical signal O_{TABCDpol} comprises the first set of information A in a first polarized sideband-pair SB_{LA2}, SB_{HA2} corresponding to the first sideband pair SB_{LAM}, SB_{HAM}, and the second set of information B in a second polarized sideband-pair SB_{LB2}, SB_{HBA5} corresponding to the second sideband pair SB_{LBM}, SB_{HBM}. Similarly, the polarization divided optical signal O_{TABCDpol} comprises in addition the third set of information C in a third polarized sideband-pair SB_{LC2}, SB_{HC2} and the fourth set of information D in a fourth polarized sideband-pair SB_{LD2}, SB_{HD2}. The sidebands in each polarized sideband-pair have an orthogonal polarization with respect to each other. The sidebands in a polarized sideband-pair comprise the same set of information.

As can be further seen in FIG. 5a′ the sidebands SB_{LD2} and SB_{LB2} are centered on the same optical frequency f_{C}−f₂, and the sidebands SB_{LC2} and SB_{LA2} are centered on the same optical frequency f_{C}−f₁, and the sidebands SB_{HA2} and SB_{HC2} are centered on the same optical frequency f_{C}+f₁, and the sidebands SB_{HB2} and SB_{HD2} are centered on the same optical frequency f_{C}+f₂. It should be emphasised that the sidebands centered on the same optical frequency as indicated here may not, in other embodiments, be centered on the same optical frequency but on nearly the same optical frequencies such that the frequency bands occupied by the sidebands are overlapping.

The optical transmitter 500a′ provides the same or similar advantages as the optical transmitter 500a previously discussed above with reference to FIG. 5a. In addition, the optical transmitter 500a′ shows the possibility of utilising a polarisation multiplexing wherein one sideband from one sideband pair and another sideband from another sideband pair can be centered on the same optical frequency in the combined polarization divided optical signal O_{TABCDpol} being transmitted from the optical transmitter 500a. It is clear that this reduces the bandwidth required of the components that produce and/or transmit the optical signal O_{TABCDpol}. Thus, an optical multiplexing as now described or similar provides an increased capacity without requiring more frequency spectrum, e.g. in the optical fiber 220. A polarization multiplexing of the kind now described o similar can also b used in the other transmitters 300a, 400a and 600a described herein.

The attention is now directed to FIG. 5b, which shows a schematic illustration of another exemplifying optical polarization diversity receiver 500b according to another embodiment of the present solution. It is preferred that the optical receiver 500b comprises the same or similar down converter arrangement 325 and optical detector arrangement 326 as the first optical receiver 300b discussed above with reference to FIG. 3b. In addition, it is preferred that the optical receiver 500b comprises a first RF-demodulator arrangement 528 and a second RF-demodulator arrangement 528′. It is also preferred that the receiver arrangement 500b comprises a diversity arrangement 529 configured to operate in the same or similar manner as the diversity arrangement 429 discussed above with reference to FIG. 4b.

The optical down converter arrangement 325 of the receiver 500b is configured to operatively receive and down convert the transmitted polarization divided optical signal O_{TAB2pol} so as to produce a down converted polarization divided optical signal O_{DAB2pol} comprising a down-converted optical version of the first sideband-pair SB_{HA2}, SB_{LA2} and a down converted version of the second sideband-pair SB_{HB2}, SB_{LB2}.

The optical detector arrangement 326 of the receiver 500b is configured to operatively detect the down converted polarization divided optical signal O_{DAB2pol} so as to produce an electrical RF-signal RF_{AB2pol} corresponding to the received polarization divided optical signal O_{TAB2pol} and the down converted polarization divided optical signal O_{DAB2pol}. The electrical RF-signal RF_{AB2pol} comprises a down-converted electrical higher sideband SB′_{HA2} and a down-converted electrical lower sideband SB′_{LA2} corresponding to the optical higher sideband SB_{HA2} and the optical lower sideband SB_{LA2} respectively of the received optical signal O_{TAB2pol}. In addition, the electrical RF-signal RF_{AB2pol} comprises a down-converted electrical higher sideband SB′_{HB2} and a down-converted electrical lower sideband SB′_{LB2} corresponding to the optical higher sideband SB_{HB2} and the optical lower sideband SB_{LB2} respectively of the received optical signal O_{TAB2pol}.

The first RF-demodulator arrangement 528 of the receiver 500b corresponds to the first RF-demodulator arrangement 328a discussed above with reference to FIG. 3b and FIG. 4b. Thus, the first RF-demodulator arrangement 528 is configured to operatively convert the electrical RF-signal RF_{AB2pol} so as to produce a first converted signal BB_{LA2} comprising the first set of information A (preferably based on the lower sideband SB′_{LA2} of the first sideband-pair SB′_{LA2}, SB′_{HA2}), and so as to produce a second converted signal BB_{HA2} comprising the same first set of information A (preferably based on the higher sideband SB′_{HA2} of the first sideband-pair SB′_{LA2}, SB′_{HA2}). To this end it is preferred that the first RF-demodulator arrangement 528 comprises a first RF-demodulator 528a configured to operatively down convert the lower sideband SB′_{LA2} (corresponding to SB_{LA2}) so as to produce the first converted signal BB_{LA2} (preferably in the form of a baseband signal), and a second RF-demodulator 528b configured to operatively down convert the higher sideband SB′_{HA2} (corresponding to SB_{HA2}) so as to produce the second converted signal BB_{HA2} (preferably in the form of a baseband signal). The RF-demodulators 528a and 528b may e.g. be of the same or similar kind as the RF-demodulators 118a and 118b described above with reference to FIG. 1. The RF-demodulators 528a and 528b may be analogue and/or digital arrangements.

The second RF-demodulator arrangement 528′ of the receiver 500b corresponds to the second RF-demodulator arrangement 328′ discussed above with reference to FIG. 3b and the second RF-demodulator arrangement 428a discussed above with reference to FIG. 4b. Thus, the second RF-demodulator arrangement 528′ is configured to operatively down convert the electrical RF-signal RF_{AB2pol} so as to produce a third converted signal BB_{LB2} comprising the second set of information B (preferably based on the lower sideband SB′_{LB2} of the second sideband-pair SB′_{LB2}, SB′_{HB2}) and so as to produce a fourth converted signal BB_{HB2} comprising the same second set of information B (preferably based on the higher sideband SB′_{HB2} of the second sideband-pair SB′_{LB2}, SB′_{HB2}). To this end it is preferred that the second RF-demodulator arrangement 528′ comprises a third RF-demodulator 528a′ configured to operatively down convert the lower sideband SB′_{LB2} (corresponding to SB_{LB2}) so as to produce the third converted signal BB_{LB2} (preferably in the form of a baseband signal), and a fourth RF-demodulator 528b′ configured to operatively down convert the higher sideband SB′_{HB2} (corresponding to SB_{HB2}) so as to produce the fourth converted signal BB_{HB2} (preferably in the form of a baseband signal). The RF-demodulators 528a′ and 528b′ may e.g. be of the same or similar kind as the RF-demodulators 118a and 118b descrinbed above with reference to FIG. 1. The RF-demodulators 528a′ and 528b′ may be analogue and/or digital arrangements.

The attention is now directed to the exemplifying diversity arrangement 529 of the receiver 500b. The diversity arrangement 529 is the same or similar as the diversity arrangement 429 discussed above with reference to FIG. 4b. Thus, the diversity arrangement 529 is configured to operatively extract the first set of information A based on the first converted signal BB_{LA2} and the second converted signal BB_{HA2} both comprising the first set of information A, and to operatively extract the second set of information B based on the third converted signal BB_{LB2} and the fourth converted signal BB_{HB2} both comprising the second set of information B. The diversity arrangement 529 may be configured to operatively use a diversity scheme operating on the first converted signal BB_{LA2} and the second converted signal BB_{HA2} to extract the first set of information A, and operating on the third converted signal BB_{LB2} and the fourth converted signal BB_{HB2} to extract the second set of information B. It is preferred that the first set of information A is extracted in the form of a first single information signal Data_{A} comprising the first set of information A, and that the second set of information B is extracted in the form of a second single information signal Data_{B} comprising the second set of information B. Thus, it is also preferred that the diversity arrangement 529 comprises a first summarizing unit 529a, a second summarizing unit 529b, a third summarizing unit 529a and a fourth summarizing unit 529b.

Generally, it is preferred that the RF-demodulators, the converted signals, the in-phase signals, the quadrature signals and the summarizing units of the receiver 400b and the receiver 500b mentioned above correspond in the following manner.

| | | | | |
|---|---|---|---|---|
| 328a [symbol] 528a | BB_{LA} [symbol] BB_{LA2} | I_{A1} [symbol] I′_{A1} | Q_{A1} [symbol] Q′_{A1} | 429a [symbol] 529a |
| 328b [symbol] 528b | BB_{HA} [symbol] BB_{HA2} | I_{A2} [symbol] I′_{A2} | Q_{A2} [symbol] Q′_{A2} | 429b [symbol] 529b |
| 428a [symbol] 528a′ | BB_{LB} [symbol] BB_{LB2} | I_{B1} [symbol] I′_{B1} | Q_{B1} [symbol] Q′_{B1} | 429a′ [symbol] 529a′ |
| 428b [symbol] 528b′ | BB_{HB} [symbol] BB_{HB2} | I_{B2} [symbol] I′_{B2} | Q_{B2} [symbol] Q′_{B2} | 429b′ [symbol] 529b′ |

The discussion previously made regarding features belonging to receiver 400b is equally applicable to the corresponding features belonging to receiver 500b now discussed. Thus, the discussion of the receiver 400b applies to the receiver 500b, except that corresponding features are interchanged, e.g. BB_{LA} and I_{A1} used when discussing receiver 400b are replaced with BB_{LA2} and I′_{A1} respectively when discussing receiver the 500b in FIG. 5b.

The exemplifying summarizing units 529a and 529b of the diversity arrangement 529 may be analogue and/or digital arrangements. An embodiment of the diversity arrangement 529 may e.g. comprise an Analogue to Digital Converter arrangement ADC and a Digital Signal Processor arrangement DSP. The DSP may be configured to implement the diversity scheme as indicated above so as to produce the output signals Data_{A} and Data_{B}. It should be added that in case the optical receiver 500b receives the multiplexed polarization divided optical signal O_{TABCDpol} or similar transmitted by transmitter 500a′ or similar described above with reference to FIG. 5a′, then the DSP to be used in the receiver 500b may e.g. be of the same or similar type as the known DSP 130 shown in FIG. 1. However, even if the DSP may be known in a few embodiments of the present solution, it should be firmly emphasized that other parts of the optical receiver 500b remain novel and inventive.

To illustrate the exemplifying operation of the optical polarization diversity transmitter 500a shown in FIG. 5a and the optical polarization diversity receiver 500b shown in FIG. 5b it may be noted that the transmitter 500a uses a first optical carrier Cₒₚₜ₁ at a frequency f_{C}, a first subcarrier f_{S1} at a frequency f₁ and a second subcarrier f_{S2} at a frequency f₂. Similarly, it may be noted that the receiver 500b uses an optical LO signal at a frequency f_{LO} and a first RF-demodulator 528a providing a first converted signal BB_{LA2} using a oscillator frequency f_{A15}=(f_{C}−f_{LO})−f1, and a second RF-demodulator 528b providing the second converted signal BB_{HA2} using a oscillator frequency f_{A25}=(f_{C}−f_{LO})+f1 and a third RF-demodulator 528a′ providing the third converted signal BB_{LB2} using a oscillator frequency f_{B15}=(f_{C}−f_{LO})−f2, and a fourth RF-demodulator 528b′ providing the fourth converted signal BB_{HB2} using a oscillator frequency f_{B25}=(f_{C}−f_{LO})+f2. Naturally, embodiments of the present solution may use other frequencies for the various carrier signals and/or oscillator signals, provided that a transmitted combined polarization divided optical signal (e.g. such as O_{TAB2pol}) can be down converted, detected and demodulated as indicated above.

As mentioned in the Background section, it is almost impossible to control the optical polarization of a signal transmitted through an optical fiber, which makes it complicated to achieve a polarization adjusted reception in ordinary optical receivers. However, in receiver 500b at least one sideband of the orthogonaly polarized sidebands SB_{LA2}, SB_{HA2} and at least one sideband of the orthogonally polarized SB_{LB2}, SB_{HB2} of the received optical signal O_{TAB2pol} will always have a sufficient signal quality. Thus, since both sidebands SB_{LA2}, SB_{HA2} comprise the same first set of information A and since both sidebands SB_{LB2}, SB_{HB2} comprise the same second set of information B it is possible to use a diversity scheme operating on the baseband signals BB_{LA2}, BB_{HA2} and BB_{LB2}, BB_{HB2} respectively to extract the first set of information A and the second set of information B respectively as indicated above, so as to assure that an output signal Data_{A} can be provided, preferably with a signal quality that is above or at least equal to the signal quality provided by any individual sideband SB_{HA2}, SB_{LA2}, SB_{HB2}, SB_{LB2} of the received optical signal O_{TAB2pol}.

It should be particularly noted that the optical detector arrangement 326 of the optical polarization diversity receiver 500b in FIG. 5b may be a single optical detector that is configured to operatively provide a coherent optical detection of the received optical signal O_{TAB2pol}.

The attention is now directed to FIG. 6a, showing a schematic illustration of another exemplifying optical polarization diversity transmitter 600a according to another embodiment of the present solution. The optical transmitter 600a is configured to operatively transmit a modulated polarization divided optical signal O_{TAB3pol} into an optical fiber 220. The optical transmitter 500a comprises the same signal generator 510, optical modulator 512 and optical oscillator device 514 as the optical polarization diversity transmitter 500a discussed above with reference to FIG. 5a.

In addition, the optical polarization diversity transmitter 600a comprises an optical polarization rotating arrangement 616.

As indicated above when discussing the other embodiments with reference to FIG. 3a, FIG. 4a and FIG. 5a, the objective of the optical polarization rotating arrangement is to polarize the sidebands in an individual sideband-pair each comprising the same set of information such that the sidebands have an orthogonal polarization with respect to each other. For example, the optical polarization rotating arrangement 516 in FIG. 5a uses a wavelength selective splitter 516a that separates the upper and lower sideband in each sideband-pair on the two sides of the optical carrier f_{C} and subsequently uses an optical polarization rotating element 516b that polarizes the lower sidebands and the higher sidebands in a sideband-pair such that the lower sideband have an orthogonal polarization with respect to the higher sideband.

The optical polarization rotating arrangement 616 of the optical transmitter 600a is preferably configured to operatively rotate the polarization state of a received optical signal (e.g. such as the optical signal O_{AB1} mentioned above) in a cyclical manner, where the amount of polarization rotation depends on the frequency content of the received optical signal, e.g. the carrier signal(s) of the optical signal or similar. It should be noted that the optical polarization rotating arrangement 616 may also be used in the embodiments described above with reference to FIGS. 3a and 4a, at least if the lower and higher sidebands of the optical sideband-pairs are positioned at suitable frequencies, e.g. as indicated below.

It is preferred that the optical polarization rotating arrangement 616 comprises a birefringence element 616a made of a birefringent material or similar being configured to operatively rotate the polarization of a received optical signal in a cyclical manner depending on the frequency content of the received optical signal and the birefringence of the birefringent material and the propagation distance of the optical signal in the birefringent material. Assuming that the birefringent optical element 616a is arranged after the modulator 512 with its polarization axes 45° relative to the polarization plane of the modulator 512, then depending on the thickness of the birefringent material, the output polarization will cyclically rotate with a fixed frequency variation. If the amount of birefringence is adapted to the frequency separation of the optical carriers of the sidebands in the optical signal O_{AB1}, every other sideband will be in orthogonal optical polarization states which forms a polarization divided optical signal O_{TAB3pol}.

As can be seen in FIG. 6a, the polarization divided optical signal O_{TAB3pol} comprises the first set of information A in a first polarized sideband-pair SB_{LA2}, SB_{HA2} corresponding to the first sideband pair SB_{LAM}, SB_{HAM} of the optical signal O_{AB1}, and the second set of information B in a second polarized sideband-pair SB_{LB3}, SB_{HBA6} corresponding to the second sideband pair SB_{LBM}, SB_{HBM} of the optical signal O_{AB1}. The sidebands in each individual sideband-pair have an orthogonal polarization with respect to each other. The sidebands in an individual sideband-pair comprise the same set of information. As can be seen in FIG. 6a, every other sideband is in orthogonal optical polarization states, i.e. SB_{LB3} has a first polarization and SB_{LA2} has a second polarisation being orthogonal with respect to the first polarisation, whereas SB_{HA2} has the same first polarisation and SB_{HB3} has same the second polarisation repeated in a cyclical manner depending on the signal frequency and the birefringence etc as indicated above. Thus, as can be clearly seen in FIG. 6a, the optical polarization rotating arrangement 616 is configured to operatively rotate the polarization of the sideband-pairs in a cyclical manner and with a fixed frequency variation such that each sideband in an individual sideband-pair receives an orthogonal polarisation with respect to each other.

FIG. 6c shows a Poincaré sphere representation of the desired polarization states of the co-propagating optical channels. Provided that two optical channels with the same data are present in orthogonal states on the Poincaré sphere, e.g. A and A′, then the State of Polarization (SOP) of the local oscillator in the receiver may reside at an arbitrary point on the surface of the sphere and the resulting beat energy after detection will always be constant. If the polarization state of the optical signal from the modulator received by the birefringent element 616a is at the SP1-point in FIG. 6c, and the rotation plane of the birefringent element is the equator plane of the Polncaré sphere, then the polarization state of an optical signal coming out from the birefringent element will appear on the equator according to the optical frequency. For example, the polarization state of the optical signal coming out from the birefringent element may be at the SP2-point in FIG. 6c giving a 180° polarization rotation with respect to the polarization state at the SP1-point of the optical signal received by the birefringent element. In the case of a single birefringent element the polarization rotation will change linearly with optical frequency, which may be sufficient in many embodiment, e.g. if the bandwidth of the optical sidebands in question is small compared to the frequency band separating the optical sidebands. The required amount of birefringence Δτ is for a single birefringent element given by Δτ=½Δf, where Δf is the frequency separation between equally spaced optical sideband where every other center frequencies become orthogonal. For higher spectral density, multiple birefringent elements can be cascaded in order to increase the bandwidth of the orthogonalizer.

The desired effect of the optical polarization rotating arrangement 616 may be accomplished by the use of liquid crystals and such optical components are becoming more and more wide spread as wavelength and polarization selective devices in optical communication systems. However, the simplest and most convenient birefringent optical element is a piece of Polarization Maintaining Fiber (PMF) that can simply be connected to a PMF coming out from the optical modulator 512 with the PMF axes rotated 45°.

The design of the optical polarization rotating arrangement 616 is much simpler compared to the other optical polarization rotating arrangements that have been discussed so far. For example, the optical polarization rotating arrangement 616 does not need any wavelength selective splitter, as is the case in the optical transmitter 500a in FIG. 5a. An additional advantage with the embodiment of the optical polarization rotating element 616 comprising a birefringence element 616a as a polarization rotator is that a birefringence based rotator can inherently operate over a wide optical frequency range making it suitable together with tuneable transmitter.

The attention is now directed to FIG. 6b, which shows a schematic illustration of the optical polarization diversity receiver 500b already discussed above with reference to FIG. 5b, however now operating in a slightly different manner as will be discussed below.

As can be seen in FIG. 6b, the optical down converter arrangement 325 of the receiver 500b is now receiving and down converting the polarization divided optical signal O_{TAB3pol} so as to produce a down converted polarization divided optical signal O_{DAB3pol} comprising a down-converted optical version of the first sideband-pair SB_{HA2}, SB_{LA2} and a down converted version of the second sideband-pair SB_{HB3}, SB_{LB3}.

Similarly, the optical detector arrangement 326 of the receiver 500b is now configured to operatively detect the down converted polarization divided optical signal O_{DAB3pol} so as to produce an electrical RF-signal RF_{AB3pol} corresponding to the down converted polarization divided optical signal O_{DAB3pol}. Thus the electrical RF-signal RF_{AB3pol} comprises a down-converted electrical higher sideband SB′_{HA2} and a down-converted electrical lower sideband SB′_{LA2} corresponding to the optical higher sideband SB_{HA2} and the optical lower sideband SB_{LA2} respectively of the received optical signal O_{TAB3pol}. In addition, the electrical RF-signal RF_{AB3pol} comprises a down-converted electrical higher sideband SB′_{HB3} and a down-converted electrical lower sideband SB′_{LB3} corresponding to the optical higher sideband SB_{HB3} and the optical lower sideband SB_{LB3} respectively of the received optical signal O_{TAB3pol}.

Similarly, the first RF-demodulator arrangement 528 is now converting the electrical RF-signal RF_{AB3pol} so as to produce a first converted signal BB_{LA2} comprising the first set of information A (preferably based on the lower sideband SB′_{LA2} of the first sideband-pair SB′_{LA2}, SB′_{HA2}) and so as to produce a second converted signal BB_{HA2} comprising the same first set of information A (preferably based on the higher sideband SB′_{HA2} of the first sideband-pair SB′_{LA2}, SB′_{HA2}). Thus, it is preferred that the first RF-demodulator 528a is now down converting the lower sideband SB′_{LA2} (corresponding to SB_{LA2}) so as to produce the first converted signal BB_{LA2} (preferably in the form of a baseband signal). Similarly, it is preferred that the second RF-demodulator 528b is now down converting the higher sideband SB′_{HA2} (corresponding to SB_{HA2}) so as to produce the second converted signal BB_{HA2} (preferably in the form of a baseband signal).

Similarly, the second RF-demodulator arrangement 528′ is now converting the electrical RF-signal RF_{AB3pol} so as to produce a third baseband signal BB_{LB3} comprising the second set of information B based on the lower sideband SB′_{LB3} of the second sideband-pair SB′_{LB3}, SB′_{HB3}, and so as to produce a fourth baseband signal BB_{HB3} comprising the same second set of information B based on the higher sideband SB′_{HB3} of the second sideband-pair SB′_{LB3}, SB′_{HB3}. Thus, it is preferred that the third RF-demodulator 528a′ is now down converting the lower sideband SB′_{LB3} (corresponding to SB_{LB3}) so as to produce the third baseband signal BB_{LB3}. Similarly, it is preferred that the fourth RF-demodulator 528b′ is now down converting the higher sideband SB′_{HB3} (corresponding to SB_{HB3}) so as to produce the fourth baseband signal BB_{HB3} (preferably in the form of a baseband signal).

A skilled person having the benefit of this disclosure realizes that the first converted signal BB_{LA6} and the second converted signal BB_{HA6} correspond to the first converted signal BB_{LA2} and the second converted signal BB_{HA2} respectively discussed above with reference to FIG. 5b. Similarly, the third converted signal BB_{LB3} and the fourth converted signal BB_{HB3} correspond to the third converted signal BB_{LB2} and the fourth converted signal BB_{HB2} respectively discussed above with reference to FIG. 5b, however now representing opposite polarizations as can be seen in FIG. 5b compared to FIG. 6b.

The diversity arrangement 529 of the receiver 500b in FIG. 6b is now configured to operatively extract the first set of information A based on a first converted signal BB_{LA2} and the second converted signal BB_{HA2} both comprising the first set of information A, and to operatively extract the second set of information B based on a third converted signal BB_{LB3} and the fourth converted signal BB_{HB3} both comprising the second set of information B. The diversity arrangement 529 may use a diversity scheme operating on the baseband signals BB_{LA2}, BB_{HA2}, BB_{LB3} and BB_{HB3} to extract the sets of data A and B, e.g. a diversity scheme operating in the same or similar manner as indicated above with respect to the diversity arrangement 429.

Generally, it is preferred that the baseband signals, the in-phase signals, the quadrature signals and the summarizing units of the receiver 500b in FIG. 6b and the receiver 500b in FIG. 5b mentioned above correspond in the following manner:

| | | | | |
|---|---|---|---|---|
| 528a [symbol] 528a | BB_{LA2} [symbol] BB_{LA2} | I′_{A1} [symbol] I′_{A1} | Q′_{A1} [symbol] Q′_{A1} | 529a [symbol] 529a |
| 528b [symbol] 528b | BB_{HA2} [symbol] BB_{HA2} | I′_{A2} [symbol] I′_{A2} | Q′_{A2} [symbol] Q′_{A2} | 529b [symbol] 529b |
| 528a′ [symbol] 528a′ | BB_{LB2} [symbol] BB_{LB3} | I′_{B1} [symbol] I″_{B1} | Q′_{B1} [symbol] Q″_{B1} | 529a′ [symbol] 529a′ |
| 528b′ [symbol] 528b′ | BB_{HB2} [symbol] BB_{HB3} | I′_{B2} [symbol] I″_{B2} | Q′_{B2} [symbol] Q″_{B2} | 529b′ [symbol] 529b′ |

The discussion previously made regarding features belonging to receiver 400b and 500b is equally applicable to the corresponding features belonging to receiver 500b operating as now discussed. Thus, the discussion of the receiver 400b applies to the receiver 500b, except that corresponding features are interchanged, e.g. BB_{LA} and I_{A1} used when discussing receiver 400b are replaced with BB_{LA2} and I′_{A1} respectively when discussing the receiver 500b in FIG. 6b.

To illustrate the exemplifying operation of the optical polarization diversity transmitter 500a shown in FIG. 6a and the optical polarization diversity receiver 500b shown in FIG. 6b it may be noted that the transmitter 500a uses a first optical carrier Cₒₚₜ₁ at a frequency f_{C}, a first subcarrier f_{S1} at a frequency f₁ and a second subcarrier f_{S2} at a frequency f₂. Similarly, it may be noted that the receiver 500b uses an optical LO signal at a frequency f_{LO} and a first RF-demodulator 528a providing a first converted signal BB_{LA2} using an oscillator frequency f_{A15}=(f_{C}−f_{LO})−f1, and a second RF-demodulator 528b providing the second converted signal BB_{HA2} using an oscillator frequency f_{A25}=(f_{C}−f_{LO})+f1 and a third RF-demodulator 528a′ providing the third converted signal BB_{LB3} using an oscillator frequency f_{B15}=(f_{C}−f_{LO})−f₂, and a fourth RF-demodulator 528b′ providing the fourth converted signal BB_{HB2} using a oscillator frequency f_{B25}=(f_{C}−f_{LO})+f₂. Naturally, embodiments of the present solution may use other frequencies for the various carrier signals and/or oscillator signals, provided that a transmitted combined polarization divided optical signal (e.g. such as O_{TAB2pol}) can be down converted, detected and demodulated as indicated above.

The attention is now directed to the flowchart in FIG. 7 illustrating the operation of some exemplifying embodiments of the present solution.

In a first action A1 it is preferred that a polarization divided optical signal (e.g. O_{TApol}. O_{TAB1pol}, O_{TAB2pol}, O_{TABCDpol} or O_{TAB3pol}) is produced and transmitted, where the polarization divided optical signal comprises optical sideband-pairs each having one sideband at a first polarization and an other sideband at a second polarization that is orthogonal to the first polarization, and where the one sideband and the other sideband carry the same set of information.

In a second action A2 it is preferred that the transmitted polarization divided optical signal is received and detected the polarization divided optical signal (e.g. O_{TApol}, O_{TAB1pol}, O_{TAB2pol} or O_{TAB3pol}) so as to produce an electrical signal (e.g. RF_{Apol}, RF_{AB1pol}, RF_{AB2pol} or RF_{AB3pol}) corresponding to the polarization divided optical signal.

In a third action A3 it is preferred that the electrical signal is down converted so as to produce, for each sideband-pair, a first converted signal corresponding to the one sideband and a second converted signal corresponding to the other sideband.

In a fourth action A4 it is preferred that the set of information is extracted for each sideband-pair using a polarization diversity scheme operating on the first converted signal and the second converted signal of each sideband-pair.

Some other embodiments discussed above may be summarized in the following manner.

One embodiment may be directed to a method for communicating information carried by a polarization divided optical signal in an optical fiber.

The method comprises the actions of:
producing and transmitting a polarization divided optical signal comprising optical sideband pairs each having one sideband at a first polarization and an other sideband at a second polarization that is orthogonal to the first polarization, and wherein the one sideband and the other sideband carry the same set of information,
receiving and detecting the polarization divided optical signal so as to produce an electrical signal corresponding to the polarization divided optical signal,
down converting the electrical signal so as to produce, for each sideband pair, a first converted signal corresponding to the one sideband and a second converted signal corresponding to the other sideband,
extracting the set of information for each sideband pair using a polarization diversity scheme operating on the first converted signal and the second converted signal of each sideband pair.

It may be mentioned that the electrical signal is down converted such that the first converted signal and the second converted signal carries the same set of information.

The method may use an individual set of two optical single sideband modulators for each individual sideband pair to produce the optical sideband pairs in the polarization divided optical signal (O_{TApol}; O_{TAB1pol}).

With respect to the transmitter 300a and 400a shown in FIG. 3a and FIG. 4a respectively It can be noted that the optical signal O_{TApol} and O_{TAB1pol} respectively may be produced such that the one sideband and the other sideband of each sideband-pair is equally distributed around an optical carrier frequency (f_{C}). This enables the use of a birefringent element or similar to polarize every other sideband in orthogonal polarization such that one sideband of each sideband-pair is polarized at the first polarization and the other sideband of each sideband-pair is polarized at the second polarization.

The method may use one optical double sideband modulator arrangement to produce the optical sideband pairs in the polarization divided optical signal such that the one sideband and the other sideband of each sideband pair is equally distributed around the optical carrier frequency modulated by the optical double sideband modulator arrangement.

The method may use one individual optical polarization rotating arrangement to operate on each individual optical sideband pair so as to polarize the one sideband of the sideband pair at the polarization divided polarization and the other sideband of the sideband pair at the second polarization. This means that one optical polarization rotating arrangement operates on a single sideband pair. Thus, there is one optical polarization rotating arrangement for each sideband pair.

The method may use an optical polarization rotating arrangement to operate on all optical sideband pairs so as to polarize the one sideband of each sideband pair at the first polarization and the other sideband of each sideband pair at the second polarization.

The method may use:
a wavelength selective splitter device of the optical polarization rotating arrangement to operate on all the sideband pairs so as to split the one sidebands being the lower sidebands and the other sidebands being the higher sidebands, and
an optical polarization rotating arrangement of the optical polarization rotating arrangement to operate on the splitted sidebands so as to polarize the lower sideband of the sideband pairs at the first polarization and the higher sideband of the sideband pairs at the second polarization.

The method may use an optical polarization rotating arrangement to operate on all optical sideband pairs so as to polarize every other sideband in orthogonal polarization such that one sideband of each sideband pair is polarized at the first polarization and the other sideband of each sideband pair is polarized at the second polarization.

The method may use a birefringence element of the optical polarization rotating arrangement to operate on all optical sideband pairs so as to polarize every other sideband in orthogonal optical polarization by rotating the polarization in a cyclical manner depending on the frequency content of each individual optical sideband pair.

In the method:
the receiving may comprise the steps of coherently receiving the polarization divided optical signal so as to produce a down converted optical signal corresponding to the polarization divided optical signal, and
the detecting may comprise the steps of detecting the down converted optical signal so as to produce an electrical signal corresponding to the polarization divided optical signal.

In the method the detecting may comprise the steps of using a single optical detector arrangement to detect the polarization divided optical signal so as to produce an electrical signal corresponding to the polarization divided optical signal.

In the method the extracting may comprise the steps of using a polarization diversity scheme operating on the first converted signal and the second converted signal so as to provide the set of information with a signal quality that Is above or at least equal to the signal quality provided by the sidebands in the corresponding optical sideband pair.

In the method the extracting may comprise the steps of using a polarization diversity scheme operating on the first converted and the second converted signal by adding the first converted signal and the second converted signal, and/or discharges one of the converted signals having a lower signal quality than the other.

Another embodiment of the present solution may be directed to an optical polarization diversity transmitter arrangement configured operatively produce and transmit a polarization divided optical signal,

The optical transmitter arrangement may comprise:
an optical modulator arrangement configured to operatively produce optical sideband pairs each having one sideband and an other sideband, wherein the one sideband and the other sideband carries the same set of information, and
an optical polarization rotating arrangement configured to operatively produce the polarization divided optical signal by polarizing the sideband pairs such that the one sideband receives a first polarization and the other sideband receives a second polarization that is orthogonal to the first polarization.

The optical modulator arrangement may comprise pairs of two optical single sideband modulators where the number of such modulator pairs is equal to the number of sideband pairs, and wherein each modulator pair is configured to produce one individual sideband pair of the of the sideband pairs in the polarization divided optical signal.

The optical modulator arrangement of the transmitter may comprise one optical double sideband modulator arrangement configured to produce all optical sideband pairs in the polarization divided optical signal such that the one sideband and the other sideband of each sideband pair is equally distributed around the optical carrier frequency modulated by the optical double sideband modulator arrangement.

The optical polarization rotating arrangement of the transmitter may comprise several optical polarization rotating arrangements where the number of polarization rotating arrangements is equal to the number of sideband pairs, and wherein each optical polarization rotating arrangement is configured to operatively polarize one individual sideband pair such that the one sideband of the sideband pair is polarized at the first polarization and the other sideband of the sideband pair is polarized at the second polarization.

The optical polarization rotating arrangement of the transmitter may comprise one optical polarization rotating arrangement configured to operatively polarize all optical sideband pairs that occur in consecutive order such that the one sideband of each sideband pair is polarized at the first polarization and the other sideband of each sideband pair is polarized at the second polarization.

The optical polarization rotating arrangement of the transmitter may comprise a wavelength selective splitter device configured to operatively split each sideband pair such that the lower sideband is separated from the higher sideband, and an optical polarization rotating arrangement configured to operatively polarize the lower sideband of the sideband pairs at the first polarization and the higher sideband of the sideband pairs at the second polarization.

The optical polarization rotating arrangement of the transmitter may be configured to operatively polarize all optical sideband pairs such that every other sideband that occur in consecutive order is polarized in orthogonal polarization such that one sideband of each sideband pair is polarized at the first polarization and the other sideband of each sideband pair is polarized at the second polarization.

The optical polarization rotating arrangement of the transmitter may comprise a birefringence element configured to operatively polarize every other sideband in orthogonal optical polarization by rotating the polarization in a cyclical manner depending on the frequency content of each individual optical sideband pair.

Still another embodiment of the present solution may be directed to an optical polarization diversity receiver arrangement configured to operatively receive a polarization divided optical signal comprising optical sideband pairs each having one sideband at a first polarization and an other sideband at a second polarization that is orthogonal to the first polarization, where the one sideband and the other sideband carries the same set of information,

The optical polarization diversity receiver arrangement may comprise:
an optical converter arrangement configured to operatively receive the polarization divided optical signal so as to produce a down converted optical signal corresponding to the polarization divided optical signal,
an optical detector arrangement configured to operatively detect the down converted optical signal so as to produce an electrical signal corresponding to the received polarization divided optical signal,
an electrical converter arrangement configured to operatively down convert the electrical signal so as to produce, for each sideband pair, a first converted signal corresponding to the one sideband and a second converted signal corresponding to the other sideband,
a diversity arrangement configured to operatively extract the set of information for each sideband pair using a polarization diversity scheme operating on the first converted signal and the second converted signal of each sideband pair.

The electrical converter arrangement of the receiver may be configured to produce an in-phase component and a quadrature component for the first converted signal, and an other in-phase component and an other quadrature component for the second converted signal.

The electrical converter arrangement of the receiver may comprise a set of two electrical converters for each sideband pair, where each set of two electrical converter arrangements is configured to operatively down convert the electrical signal so as to produce the first converted signal and the second converted signal for one individual sideband pair.

The receiver may comprise a single optical detector arrangement configured to operatively detect the polarization divided optical signal so as to produce the electrical signal corresponding to the polarization divided optical signal.

The diversity arrangement of the receiver may be configured to operatively use a polarization diversity scheme to operate on the first converted signal and the second converted signal so as to provide the set of information with a signal quality that is above or at least equal to the signal quality provided by the sidebands in the corresponding optical sideband pair.

The diversity arrangement of the receiver may be configured to operatively use a polarization diversity scheme to operate on the first converted signal and the second converted signal so as to provide the set of information by adding the first converted signal and the second converted signal, and/or discharge the one of first converted signal or the second converted signal having a lower signal quality than the other.

Another embodiment may be directed to a system for communicating information carried by a polarization divided optical signal in an optical fiber, wherein:

The system may have an optical transmitter configured to operatively produce and transmit a polarization divided optical signal comprising optical sideband pairs each having one sideband and an other sideband, where the one sideband and the other sideband carries the same set of information.

The system may also have an optical receiver configured to operatively:
receive and detect the polarization divided optical signal so as to produce an electrical signal corresponding to the polarization divided optical signal,
down convert the electrical signal so as to produce, for each sideband pair, a first converted signal corresponding to the one sideband and a second converted signal corresponding to the other sideband
extract the set of information for each sideband pair using a polarization diversity scheme operating on the first converted signal and the second converted signal of each sideband pair.

The transmitter of the system may comprise an optical modulator arrangement comprising pairs of two optical single sideband modulators where the number of such modulator pairs is equal to the number of sideband pairs, and wherein each modulator pair is configured to operatively produce one individual sideband pair of the of the sideband pairs in the polarization divided optical signal.

The transmitter of the system may comprise one optical double sideband modulator arrangement configured to produce an optical sideband pairs in the polarization divided optical signal such that the one sideband and the other sideband of each sideband pair is equally distributed around an optical carrier frequency modulated by the optical double sideband modulator arrangement.

The transmitter of the system may comprise a number of optical polarization rotating arrangements equal to the number of sideband pairs, wherein each optical polarization rotating arrangement is configured to operatively polarize one individual sideband pair of the sideband pairs such that the one sideband of the sideband pair is polarized at the first polarization and the other sideband of the sideband pair is polarized at the second polarization.

The transmitter of the system may comprise one optical polarization rotating arrangement configured to operatively polarize all optical sideband pairs that occur in consecutive order such that the one sideband of each sideband pair is polarized at the first polarization and the other sideband of each sideband pair is polarized at the second polarization.

The optical polarization rotating arrangement of the transmitter in the system may comprise a wavelength selective splitter device configured to operatively split the sideband pairs such that the one sidebands being the lower sidebands are separated from the other sidebands being the higher sidebands, and the optical polarization rotating arrangement (516) comprises an optical polarization rotating element configured to operatively polarize the lower sideband of the sideband pairs at the first polarization and the higher sideband of the sideband pairs at the second polarization.

The optical polarization rotating arrangement of the transmitter in the system may be configured to operatively polarize all optical sideband pairs such that every other sideband that occur in consecutive order is polarized in orthogonal polarization such that one sideband of each sideband pair is polarized at the first polarization and the other sideband of each sideband pair is polarized at the second polarization.

The optical polarization rotating arrangement of the transmitter in the system may comprise a birefringence element configured to operatively polarize every other sideband in orthogonal optical polarization by rotating the polarization in a cyclical manner depending on the frequency content of each individual optical sideband pair.

The receiver of the system may comprise:
an optical converter arrangement configured to operatively receive the transmitted polarization divided optical signal so as to produce a down converted optical signal corresponding to the polarization divided optical signal,
an optical detector arrangement configured to operatively detect the down converted optical signal so as to produce an electrical signal corresponding to the received polarization divided optical signal,
an electrical converter arrangement configured to operatively down convert the electrical signal so as to produce, for each sideband pair, a first converted signal corresponding to the one sideband and a second converted signal corresponding to the other sideband, and
a diversity arrangement configured to operatively extract the set of information for each sideband pair using a polarization diversity scheme operating on the first converted signal and the second converted signal of each sideband pair.

The electrical converter arrangement of the receiver in the system may be configured to produce an in-phase component and a quadrature component for the first converted signal, and an other in-phase component and an other quadrature component for the second converted signal.

The electrical converter arrangement of the receiver in the system may comprise a set of two electrical converters for each sideband pair, where each set of two electrical converter arrangements is configured to operatively down convert the electrical signal so as to produce the first converted signal and the second converted signal for one individual sideband pair.

The receiver in the system may comprise a single optical detector arrangement configured to operatively detect the polarization divided optical signal so as to produce the electrical signal corresponding to the polarization divided optical signal.

The diversity arrangement of the receiver in the system may be configured to operatively use a polarization diversity scheme to operate on the first converted signal and the second converted signal so as to provide the set of information with a signal quality that is above or at least equal to the signal quality provided by the sidebands in the corresponding optical sideband pair.

The diversity arrangement of the receiver in the system may be configured to operatively use a polarization diversity scheme to operate on the first converted signal and the second converted signal so as to provide the set of information by adding the first converted signal and the second converted signal, and/or discharge the one of first converted signal or the second converted signal having a lower signal quality than the other.

The present invention has now been described with reference to exemplifying embodiments. However, the invention is not limited to the embodiments described herein. On the contrary, the full extent of the invention is only determined by the scope of the appended claims.

1. A method for communicating information carried by a polarization divided optical signal in an optical fiber comprising:
producing and transmitting a polarization divided optical signal (O_{TApol}; O_{TAB1pol}; O_{TAB2pol}; O_{TAB3pol}) comprising optical sideband-pairs (SB_{LA}, SB_{HA}; SB_{LA}, SB_{HA}, SB_{LB}, SB_{HB}; SB_{LA2}, SB_{HA2}, SB_{LB2}, SB_{HB2}; SB_{LA2}, SB_{HA2}, SB_{LB3}, SB_{HB3}) each having one sideband (SB_{LA}; SB_{LA}, SB_{LB}; SB_{LA2}, SB_{LB2}; SB_{LA2}, SB_{LB3}) at a first polarization and an other sideband (SB_{HA}; SB_{HA}, SB_{HB}; SB_{HA2}, SB_{HB2}; SB_{HA2}, SB_{HB3}) at a second polarization that is orthogonal to the first polarization, and where the one sideband and the other sideband carry the same set of Information (A; A, B);
receiving and detecting the polarization divided optical signal (O_{TApol}; O_{TAB1pol}; O_{TAB2pol}; O_{TAB3pol}) so as to produce an electrical signal (RF_{Apol}; RF_{AB1pol}; RF_{AB2pol}; RF_{AB3pol}) corresponding to the polarization divided optical signal;
down converting the electrical signal so as to produce, for each sideband pair, a first converted signal (BB_{LA}; BB_{LA}, BB_{LB}; BB_{LA2}, BB_{LB2}; BB_{LA2}, BB_{LB3}) corresponding to the one sideband (SB_{LA}; SB_{LA}, SB_{LB}; SB_{LA2}, SB_{LB2}; SB_{LA2}, SB_{LA3}) and a second converted signal (BB_{HA}; BB_{HA}, BB_{HB}; BB_{HA2}, BB_{HB2}; BB_{HA2}, BB_{HB3}) corresponding to the other sideband (SB_{HA}; SB_{HA}, SB_{HB}; SB_{HA2}, SB_{HB2}; SB_{HA2}, SB_{HA3}); and
extracting the set of information (A; A, B) for each sideband pair using a polarization diversity scheme operating on the first converted signal and the second converted signal of each sideband pair.

2. The method according to claim 1, wherein:
an individual set of two optical single sideband modulators is used for each individual sideband pair (SB_{LA}, SB_{HA}; SB_{LA}, SB_{HA}; SB_{LB}, SB_{HB}) to produce the optical sideband-pairs in the polarization divided optical signal (O_{TApol}; O_{TAB1pol}).

3. The method according to claim 1, wherein:
one optical double sideband modulator arrangement is used to produce the optical sideband pairs (SB_{LA2}, SB_{HA2}, SB_{LB2}, SB_{HB2}; SB_{LA2}, SB_{HA2}, SB_{LB3}, SB_{HB3}) in the polarization divided optical signal (O_{TAB2pol}; O_{TAB3pol}) such that the one sideband and the other sideband of each sideband-pair is equally distributed around the optical carrier frequency (f_{C}) modulated by the optical double sideband modulator arrangement.

4. The method according to claim 1, wherein:
one individual optical polarization rotating arrangement operates on each individual optical sideband pair (SB_{LA}, SB_{HA}; SB_{LA}, SB_{HA}, SB_{LB}, SB_{HB}) so as to polarize the one sideband (SB_{LA}; SB_{LA}, SB_{LB}) of the sideband-pair at the polarization divided polarization and the other sideband (SB_{HA}; SB_{HA}, SB_{HB}) of the sideband pair at the second polarization.

5. The method according to claim 1, wherein:
an optical polarization rotating arrangement operates on all optical sideband pairs (SB_{LA2}, SB_{HA2}, SB_{LB2}, SB_{HB2}; SB_{LA2}, SB_{HA2}, SB_{LB3}, SB_{HB3}) so as to polarize the one sideband (SB_{LA2}, SB_{LB2}; SB_{LA2}, SB_{HB3}) of each sideband-pair at the first polarization and the other sideband (SB_{HA2}, SB_{HB2}; SB_{HA2}, SB_{LB3}) of each sideband pair at the second polarization.

6. The method according to claim 5, wherein:
a wavelength selective splitter device of the optical polarization rotating arrangement operates on all the sideband pairs (SB_{LA2}, SB_{HA2}, SB_{LB2}, SB_{HB2}) so as to split the one sidebands being the lower sidebands (SB_{LA2}, SB_{LB2}) and the other sidebands being the higher sidebands (SB_{HA2}, SB_{HB2}); and
an optical polarization rotating element of the optical polarization rotating arrangement operates on the splitted sidebands so as to polarize the lower sideband of the sideband pairs at the first polarization and the higher sideband of the sideband pairs at the second polarization.

7. The method according to claim 5, wherein:
the optical polarization rotating arrangement operates on all optical sideband pairs (SB_{LA2}, SB_{HA2}, SB_{LB3}, SB_{HB3}) so as to polarize every other sideband in orthogonal polarization such that one sideband (SB_{LA2}, SB_{HB3}) of each sideband-pair is polarized at the first polarization and the other sideband (SB_{HA2}, SB_{LB3}) of each sideband pair is polarized at the second polarization.

8. The method according to claim 7, wherein:
a birefringence element of the optical polarization rotating arrangement operates on all optical sideband pairs (SB_{LA2}, SB_{HA2}, SB_{LB3}, SB_{HB3}) so as to polarize every other sideband in orthogonal optical polarization by rotating the polarization in a cyclical manner depending on the frequency content of each individual optical sideband pair.

9. The method according to claim 1, wherein:
the receiving comprises the steps of coherently receiving the polarization divided optical signal (O_{TApol}; O_{TAB1pol}; O_{TAB2pol}; O_{TAB3pol}) so as to produce a down converted optical signal (O_{DApol}; O_{DAB1pol}; O_{DAB2pol}; O_{DAB3pol}) corresponding to the polarization divided optical signal; and
the detecting comprises the steps of detecting the down converted optical signal (O_{DApol}; O_{DAB1pol}; O_{DAB2pol}; O_{DAB3pol}) so as to produce the electrical signal (RF_{Apol}; RF_{AB1pol}; RF_{AB2pol}; RF_{AB3pol}).

10. The method according to claim 1, wherein:
the detecting comprises the steps of using a single optical detector arrangement to detect the polarization divided optical signal (O_{TApol}; O_{TAB1pol}; O_{TAB2pol}; O_{TAB3pol}) so as to produce the electrical signal (RF_{Apol}; RF_{AB1pol}; RF_{AB2pol}; RF_{AB3pol}) corresponding to the polarization divided optical signal.

11. The method according to claim 1, wherein:
the extracting comprises the steps of using a polarization diversity scheme operating on the first converted signal (BB_{LA}; BB_{LA}, BB_{LB}; BB_{LA2}, BB_{LB2}; BB_{LA2}, BB_{LB3}) and the second converted signal (BB_{HA}; BB_{HA}, BB_{HB}; BB_{HA2}, BB_{HB2}; BB_{HA2}, BB_{HB3}) so as to provide the set of information (A; B) with a signal quality that is above or at least equal to the signal quality provided by the sidebands in the corresponding optical sideband pair.

12. The method according to claim 1, wherein:
the extracting comprises the steps of using a polarization diversity scheme operating on the first converted signal and the second converted signal by adding the first converted signal and the second converted signal, and/or discharges one of the converted signals having a lower signal quality than the other.

13. An optical polarization diversity transmitter arrangement configured to operatively produce and transmit a polarization divided optical signal (O_{TApol}; O_{TAB1pol}; O_{TAB2pol}; O_{TAB3pol}), wherein:
an optical modulator arrangement is configured to operatively produce optical sideband pairs (SB_{LA}, SB_{HA}; SB_{LA}, SB_{HA}, SB_{LB}, SB_{HB}; SB_{LA2}, SB_{HA2}, SB_{LB2}, SB_{HB2}; SB_{LA2}, SB_{HA2}, SB_{LB3}, SB_{HB3}) each having one sideband (SB_{LA}; SB_{LA}, SB_{LB}; SB_{LA2}, SB_{LB2}; SB_{LA2}, SB_{LB3}) and an other sideband (SB_{HA}; SB_{HA}, SB_{HB}; SB_{HA2}, SB_{HB2}; SB_{HA2}, SB_{HB3}), where the one sideband and the other sideband carry the same set of Information (A; A, B);
an optical polarization rotating arrangement is configured to operatively produce the polarization divided optical signal (O_{TApol}; O_{TAB1pol}; O_{TAB2pol}; O_{TAB3pol}) by polarizing the sideband pairs such that the one sideband receives a first polarization and the other sideband receives a second polarization that is orthogonal to the first polarization.

14. An optical transmitter according to claim 13, wherein:
the optical modulator arrangement comprises pairs of two optical single sideband modulators where the number of such modulator pairs is equal to the number of sideband pairs, and wherein each modulator pair is configured to produce one individual sideband pair (SB_{LA}, SB_{HA}; SB_{LA}, SB_{HA}; SB_{LB}, SB_{HB}) of the of the sideband-pairs in the polarization divided optical signal (O_{TApol}; O_{TAB1pol}).

15. An optical transmitter according to claim 13, wherein:
the optical modulator arrangement comprises one optical double sideband modulator arrangement configured to produce all optical sideband pairs (SB_{LA2}, SB_{HA2}, SB_{LB2}, SB_{HB2}; SB_{LA2}, SB_{HA2}, SB_{LB3}, SB_{HB3}) in the polarization divided optical signal (O_{TAB2pol}; O_{TAB3pol}) such that the one sideband and the other sideband of each sideband-pair is equally distributed around the optical carrier frequency (f_{C}) modulated by the optical double sideband modulator arrangement.

16. An optical transmitter according to claim 13, wherein:
the optical polarization rotating arrangement comprises several optical polarization rotating arrangements where the number of polarization rotating arrangements is equal to the number of sideband pairs, and wherein each optical polarization rotating arrangement is configured to operatively polarize one individual sideband pair such that the one sideband (SB_{LA}; SB_{LA}, SB_{LB}) of the sideband-pair is polarized at the first polarization and the other sideband (SB_{HA}; SB_{HA}, SB_{HB}) of the sideband pair is polarized at the second polarization.

17. An optical transmitter according to claim 13, wherein:
the optical polarization rotating arrangement comprises one optical polarization rotating arrangement configured to operatively polarize all optical sideband pairs (SB_{LA2}, SB_{HA2}, SB_{LB2}, SB_{HB2}; SB_{LA2}, SB_{HA2}, SB_{LB3}, SB_{HB3}) that occur in consecutive order such that the one sideband (SB_{LA2}, SB_{LB2}; SB_{LA2}, SB_{HB3}) of each sideband-pair is polarized at the first polarization and the other sideband (SB_{HA2}, SB_{HB2}; SB_{HA2}, SB_{LB3}) of each sideband pair is polarized at the second polarization.

18. An optical transmitter according to claim 17, wherein the optical polarization rotating arrangement comprises:
a wavelength selective splitter device configured to operatively split each sideband pair (SB_{LA2}, SB_{HA2}, SB_{LB2}, SB_{HB2}) such that the lower sideband (SB_{LA2}, SB_{LB2}) is separated from the higher sideband (SB_{HA2}, SB_{HB2}); and
an optical polarization rotating element configured to operatively polarize the lower sideband of the sideband pairs at the first polarization and the higher sideband of the sideband pairs at the second polarization.

19. An optical transmitter according to claim 17, wherein:
the optical polarization rotating arrangement is configured to operatively polarize all optical sideband pairs ((SB_{LA2}, SB_{HA2}, SB_{LB2}, SB_{HB2}; SB_{LA2}, SB_{HA2}, SB_{LB3}, SB_{HB3}) such that every other sideband that occur in consecutive order is polarized in orthogonal polarization such that one sideband (SB_{LA2}, SB_{HB3}) of each sideband-pair is polarized at the first polarization and the other sideband (SB_{HA2}, SB_{LB3}) of each sideband pair is polarized at the second polarization.

20. An optical transmitter according to claim 19, wherein:
the optical polarization rotating arrangement comprises a birefringence element configured to operatively polarize every other sideband in orthogonal optical polarization by rotating the polarization in a cyclical manner depending on the frequency content of each individual optical sideband pair.

21. A optical polarization diversity receiver configured to operatively receive a polarization divided optical signal (O_{TApol}; O_{TAB1pol}; O_{TAB2pol}; O_{TAB3pol}) comprising optical sideband-pairs (SB_{LA}, SB_{HA}; SB_{LA}, SB_{HA}, SB_{LB}, SB_{HB}; SB_{LA2}, SB_{HA2}, SB_{LB2}, SB_{HB2}; SB_{LA2}, SB_{HA2}, SB_{LB3}, SB_{HB3}) each having one sideband (SB_{LA}; SB_{LA}, SB_{LB}; SB_{LA2}, SB_{LB2}; SB_{LA2}, SB_{LB3}) at a first polarization and an other sideband (SB_{HA}; SB_{HA}, SB_{HB}; SB_{HA2}, SB_{HB2}; SB_{HA2}, SB_{HB3}) at a second polarization that is orthogonal to the first polarization, where the one sideband and the other sideband carries the same set of information (A; A, B), wherein:
an optical converter arrangement is configured to operatively receive the polarization divided optical signal (O_{TApol}; O_{TAB1pol}; O_{TAB2pol}; O_{TAB3pol}) so as to produce a down converted optical signal (O_{DApol}; O_{DAB1pol}; O_{DAB2pol}; O_{DAB3pol}) corresponding to the polarization divided optical signal;
an optical detector arrangement is configured to operatively detect the down converted optical signal so as to produce an electrical signal (RF_{Apol}; RF_{AB1pol}; RF_{AB2pol}; RF_{AB3pol}) corresponding to the received polarization divided optical signal;
an electrical converter arrangement is configured to operatively down convert the electrical signal so as to produce, for each sideband pair, a first converted signal (BB_{LA}; BB_{LA}, BB_{LB}; BB_{LA2}, BB_{LB2}; BB_{LA2}, BB_{LB3}) corresponding to the one sideband (SB_{LA}; SB_{LA}, SB_{LB}; SB_{LA2}, SB_{LB2}; SB_{LA2}, SB_{LA3}) and a second converted signal (BB_{HA}; BB_{HA}, BB_{HB}; BB_{HA2}, BB_{HB2}; BB_{HA2}, BB_{HB3}) corresponding to the other sideband (SB_{HA}; SB_{HA}, SB_{HB}; SB_{HA2}, SB_{HB2}; SB_{HA2}, SB_{HA3}); and
a diversity arrangement is configured to operatively extract the set of information (A; A, B) for each sideband pair using a polarization diversity scheme operating on the first converted signal and the second converted signal of each sideband pair.

22. An optical receiver according to claim 21, wherein:
the electrical converter arrangement is configured to produce an in phase component (I_{A1}; I_{A1}, I_{B1}; I′_{A1}, I′_{B1}; I′_{A1}, I″_{B1}) and a quadrature component (Q_{A1}; Q_{A1}, Q_{B1}; Q′_{A1}, Q′_{B1}; Q′_{A1}, Q″_{B1}) for the first converted signal, and an other in-phase component (I_{A2}; I_{A2}, I_{B2}; I′_{A2}, I′_{B2}; I′_{A2}, I″_{B2}) and an other quadrature component (Q_{A2}; Q_{A2}, Q_{B2}; Q′_{A2}, Q′_{B2}; Q′_{A2}, Q″_{B2}) for the second converted signal.

23. An optical receiver according to claim 21, wherein:
the electrical converter arrangement comprises a set of two electrical converters for each sideband pair, where each set of two electrical converter arrangements is configured to operatively down convert the electrical signal so as to produce the first converted signal and the second converted signal for one individual sideband pair.

24. An optical receiver according to claim 21, wherein:
a single optical detector arrangement is configured to operatively detect the polarization divided optical signal (O_{TApol}; O_{TAB1pol}; O_{TAB2pol}; O_{TAB3pol}) so as to produce the electrical signal (RF_{Apol}; RF_{AB1pol}; RF_{AB2pol}; RF_{AB3pol}) corresponding to the polarization divided optical signal.

25. An optical receiver according to claim 21, wherein:
the diversity arrangement is configured to operatively use a polarization diversity scheme to operate on the first converted signal and the second converted signal so as to provide the set of information (A; B) with a signal quality that is above or at least equal to the signal quality provided by the sidebands in the corresponding optical sideband pair.

26. An optical receiver according to claim 21, wherein:
the diversity arrangement is configured to operatively use a polarization diversity scheme to operate on the first converted signal and the second converted signal so as to provide the set of information (A; B) by adding the first converted signal and the second converted signal, and/or discharge the one of first converted signal or the second converted signal having a lower signal quality than the other.

27. A system for communicating information carried by a polarization divided optical signal in an optical fiber, wherein:
an optical polarization diversity transmitter is configured to operatively produce and transmit a polarization divided optical signal (O_{TApol}; O_{TAB1pol}; O_{TAB2pol}; O_{TAB3pol}), comprising optical sideband-pairs (SB_{LA}, SB_{HA}; SB_{LA}, SB_{HA}, SB_{LB}, SB_{HB}; SB_{LA2}, SB_{HA2}, SB_{LB2}, SB_{HB2}; SB_{LA2}, SB_{HA2}, SB_{LB3}, SB_{HB3}) each having one sideband (SB_{LA}; SB_{LA}, SB_{LB}; SB_{LA2}, SB_{LB2}; SB_{LA2}, SB_{LB3}) and an other sideband (SB_{HA}; SB_{HA}, SB_{HB}; SB_{HA2}, SB_{HB2}; SB_{HA2}, SB_{HB3}), where the one sideband and the other sideband carries the same set of information (A; A, B); and
an optical polarization diversity receiver is configured to operatively:
receive and detect the polarization divided optical signal (O_{TApol}; O_{TAB1pol}; O_{TAB2pol}; O_{TAB3pol}) so as to produce an electrical signal (RF_{Apol}; RF_{AB1pol}; RF_{AB2pol}; RF_{AB3pol}) corresponding to the polarization divided optical signal;
down convert the electrical signal so as to produce, for each sideband pair, a first converted signal (BB_{LA}; BB_{LA}, BB_{LB}; BB_{LA2}, BB_{LB2}; BB_{LA2}, BB_{LB3}) corresponding to the one sideband (SB_{LA}; SB_{LA}, SB_{LB}; SB_{LA2}, SB_{LB2}; SB_{LA2}, SB_{LA3}) and a second converted signal (BB_{HA}; BB_{HA}, BB_{HB}; BB_{HA2}, BB_{HB2}; BB_{HA2}, BB_{HB3}) corresponding to the other sideband (SB_{HA}; SB_{HA}, SB_{HB}; SB_{HA2}, SB_{HB2}; SB_{HA2}, SB_{HA3}); and
extract the set of Information (A; A, B) for each sideband pair using a polarization diversity scheme operating on the first converted signal and the second converted signal of each sideband pair.

28. The system according to claim 27, wherein:
the transmitter comprises an optical modulator arrangement comprising pairs of two optical single sideband modulators where the number of such modulator pairs is equal to the number of sideband pairs, and wherein each modulator pair is configured to operatively produce one individual sideband pair (SB_{LA}, SB_{HA}; SB_{LA}, SB_{HA}; SB_{LB}, SB_{HB}) of the of the sideband-pairs in the polarization divided optical signal (O_{TApol}; O_{TAB1pol}).

29. The system according to claim 27, wherein:
the transmitter comprises one optical double sideband modulator arrangement configured to produce all optical sideband pairs (SB_{LA2}, SB_{HA2}, SB_{LB2}, SB_{HB2}; SB_{LA2}, SB_{HA2}, SB_{LB3}, SB_{HB3}) in the polarization divided optical signal (O_{TAB2pol}; O_{TAB3pol}) such that the one sideband and the other sideband of each sideband-pair is equally distributed around the optical carrier frequency (f_{C}) modulated by the optical double sideband modulator arrangement.

30. The system according to claim 27, wherein:
the transmitter comprises a number of optical polarization rotating arrangements equal to the number of sideband pairs, wherein each optical polarization rotating arrangement is configured to operatively polarize one individual sideband pair of the sideband pairs such that the sideband (SB_{LA}; SB_{LA}, SB_{LB}) of the sideband-pair is polarized at the first polarization and the other sideband (SB_{HA}; SB_{HA}, SB_{HB}) of the sideband-pair is polarized at the second polarization.

31. The system according to claim 27, wherein:
the transmitter comprises one optical polarization rotating arrangement, configured to operatively polarize all optical sideband-pairs (SB_{LA2}, SB_{HA2}, SB_{LB2}, SB_{HB2}; SB_{LA2}, SB_{HA2}, SB_{LB3}, SB_{HB3}) that occur in consecutive order such that the one sideband (SB_{LA2}, SB_{LB2}; SB_{LA2}, SB_{HB3}) of each sideband-pair is polarized at the first polarization and the other sideband (SB_{HA2}, SB_{HB2}; SB_{HA2}, SB_{LB3}) of each sideband-pair is polarized at the second polarization.

32. The system according to claim 31, wherein:
the optical polarization rotating arrangement comprises a wavelength selective splitter device configured to operatively split the sideband pairs (SB_{LA2}, SB_{HA2}, SB_{LB2}, SB_{HB2}) such that the one sidebands being the lower sidebands (SB_{LA2}, SB_{LB2}) are separated from the other sidebands being the higher sidebands (SB_{HA2}, SB_{HB2}); and
the optical polarization rotating arrangement comprises an optical polarization rotating element configured to operatively polarize the lower sideband of the sideband pairs at the first polarization and the higher sideband of the sideband pairs at the second polarization.

33. The system according to claim 31, wherein:
the optical polarization rotating arrangement is configured to operatively polarize all optical sideband pairs (SB_{LA2}, SB_{HA2}, SB_{LB2}, SB_{HB2}; SB_{LA2}, SB_{HA2}, SB_{LB3}, SB_{HB3}) such that every other sideband that occur in consecutive order is polarized in orthogonal polarization such that one sideband (SB_{LA2}, SB_{HB3}) of each sideband-pair is polarized at the first polarization and the other sideband (SB_{HA2}, SB_{LB3}) of each sideband-pair is polarized at the second polarization.

34. The system according to claim 33, wherein:
the optical polarization rotating arrangement comprises a birefringence element configured to operatively polarize every other sideband in orthogonal optical polarization by rotating the polarization in a cyclical manner depending on the frequency content of each individual optical sideband pair.

35. The system according to claim 27, wherein the receiver comprises:
an optical converter arrangement configured to operatively receive the polarization divided optical signal (O_{TApol}; O_{TAB1pol}; O_{TAB2pol}; O_{TAB3pol}) so as to produce a down converted optical signal (O_{DApol}; O_{DAB1pol}; O_{DAB2pol}; O_{DAB3pol}) corresponding to the polarization divided optical signal;
an optical detector arrangement configured to operatively detect the down converted optical signal so as to produce an electrical signal (RF_{Apol}; RF_{AB1pol}; RF_{AB2pol}; RF_{AB3pol}) corresponding to the received polarization divided optical signal;
an electrical converter arrangement configured to operatively down convert the electrical signal so as to produce, for each sideband pair, a first converted signal (BB_{LA}; BB_{LA}, BB_{LB}; BB_{LA2}, BB_{LB2}; BB_{LA2}, BB_{LB3}) corresponding to the one sideband (SB_{LA}; SB_{LA}, SB_{LB}; SB_{LA2}, SB_{LB2}; SB_{LA2}, SB_{LA3}) and a second converted signal (BB_{HA}; BB_{HA}, BB_{HB}; BB_{HA2}, BB_{HB2}; BB_{HA2}, BB_{HB3}) corresponding to the other sideband (SB_{HA}; SB_{HA}, SB_{HB}; SB_{HA2}, SB_{HB2}; SB_{HA2}, SB_{HA3}); and
a diversity arrangement configured to operatively extract the set of information (A; A, B) for each sideband pair using a polarization diversity scheme operating on the first converted signal and the second converted signal of each sideband pair.

36. The system according to claim 35, wherein:
the electrical converter arrangement is configured to produce an in phase component (I_{A1}; I_{A1}, I_{B1}; I′_{A1}, I′_{B1}; I′_{A1}, I″_{B1}) and a quadrature component (Q_{A1}; Q_{A1}, Q_{B1}; Q′_{A1}, Q′_{B1}; Q′_{A1}, Q″_{B1}) for the first converted signal, and an other in phase component (I_{A2}; I_{A2}, I_{B2}; I′_{A2}, I′_{B2}; I′_{A2}, I″_{B2}) and an other quadrature component (Q_{A2}; Q_{A2}, Q_{B2}; Q′_{A2}, Q′_{B2}; Q′_{A2}, Q″_{B2}) for the second converted signal.

37. The system according to claim 36, wherein:
the electrical converter arrangement comprises a set of two electrical converters for each sideband pair, where each set of two electrical converter arrangements is configured to operatively down convert the electrical signal so as to produce the first converted signal and the second converted signal for one individual sideband pair.

38. The system according to claim 35, wherein:
a single optical detector arrangement is configured to operatively detect the polarization divided optical signal (O_{TApol}; O_{TAB1pol}; O_{TAB2pol}; O_{TAB3pol}) so as to produce the electrical signal (RF_{Apol}; RF_{AB1pol}; RF_{AB2pol}; RF_{AB3pol}) corresponding to the polarization divided optical signal.

39. The system according to claim 35, wherein:
the diversity arrangement is configured to operatively use a polarization diversity scheme to operate on the first converted signal and the second converted signal so as to provide the set of information (A; B) with a signal quality that is above or at least equal to the signal quality provided by the sidebands in the corresponding optical sideband pair.

40. The system according to claim 35, wherein:
the diversity arrangement is configured to operatively use a polarization diversity scheme to operate on the first converted signal and the second converted signal so as to provide the set of information (A; B) by adding the first converted signal and the second converted signal, and/or discharge the one of first converted signal or the second converted signal having a lower signal quality than the other.
